(19) United States
(12) Patent Application Publication
(10) Pub. No.: US 2007/0203653 A1
(43) Pub. Date: Aug. 30, 2007

(54) Method and system for computational detection of common aberrations from multi-sample comparative genomic hybridization data sets

(76) Inventors: Amir Ben-Dor, Bellevue, WA (US); Anya Tsalenko, Chicago, IL (US); Doron Lipson, Rehovot (IL); Zohar Yakhini, Ramat Hasharon (IL)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/363,699

(22) Filed: Feb. 28, 2006

(51) Int. Cl. G06F 19/00

(52) U.S. Cl. 702/19; 702/20

(57) ABSTRACT

Various embodiments of the present invention are directed to methods and systems for automatic, statistically meaningful detection of aberrations common to multiple samples within a sample set. Many various aberration-calling techniques are used to identify aberrant intervals within each of the samples of the sample set. A set of candidate intervals is constructed to include the aberrant intervals identified by the aberration-calling technique, as well as two-way intersections of the identified aberrant intervals. A score indicating the statistical relevance of each candidate interval with respect to each sample is next assigned to each candidate interval. Then, a total significance score is assigned to each candidate interval based on the individual scores for the candidate interval with respect to each sample. The most statistically significant candidate intervals may be selected based on the total significance scores assigned to the candidate intervals.

### TECHNICAL FIELD OF THE INVENTION

The present invention is related to analysis of comparative genomic hybridization data, and, in particular, to various method and system embodiments for detecting aberrations that are common to multiple samples from which the comparative genomic hybridization data has been obtained.

### BACKGROUND OF THE INVENTION

A great deal of basic research has been carried out to elucidate the causes and cellular mechanisms responsible for transformation of normal cells to precancerous and cancerous states and for the growth of, and metastasis of, cancerous tissues. Enormous strides have been made in understanding various causes and cellular mechanisms of cancer, and this detailed understanding is currently providing new and useful approaches for preventing, detecting, and treating cancer.

There are myriad different types of causative events and agents associated with the development of cancer, and there are many different types of cancer and many different patterns of cancer development for each of the many different types of cancer. Although initial hopes and strategies for treating cancer were predicated on finding one or a few basic, underlying causes and mechanisms for cancer, researchers have, over time, recognized that what they initially described generally as “cancer” appears to, in fact, be a very large number of different diseases. Nonetheless, there do appear to be certain common cellular phenomena associated with the various diseases described by the term “cancer.” One common phenomenon, evident in many different types of cancer, is the onset of genetic instability in precancerous tissues, and progressive genomic instability as cancerous tissues develop. While there are many different types and manifestations of genomic instability, a change in the number of copies of particular DNA subsequences within chromosomes and changes in the number of copies of entire chromosomes within a cancerous cell may be a fundamental indication of genomic instability. Although cancer is one important pathology correlated with genomic instability, changes in gene copies within individuals, or relative changes in gene copies between related individuals, may also be causally related to, correlated with, or indicative of other types of pathologies and conditions, for which techniques to detect gene-copy changes may serve as useful diagnostic, treatment development, and treatment monitoring aids.

Various techniques have been developed to detect and at least partially quantify amplification and deletion of chromosomal DNA subsequences in cancerous cells. One technique is referred to as “comparative genomic hybridization.” Comparative genomic hybridization (“CGH”) can offer striking, visual indications of chromosomal-DNA-subsequence amplification and deletion, in certain cases, but, like many biological and biochemical analysis techniques, is subject to significant noise and sample variation, leading to problems in quantitative analysis of CGH data. Array-based comparative genomic hybridization (“aCGH”) has been relatively recently developed to provide a higher resolution, highly quantitative comparative-genomic-hybridization technique. Although providing increased accuracy and resolution, as well as far most cost-effective and time-efficient generation of comparative genomic hybridization data, the task of computationally analyzing aCGH data and extracting statistically meaningful information from the data remains daunting error prone. The recently developed aCGH techniques, for example, allow for rapid and cost-effective generation of aCGH data from large numbers of chromosomal DNA samples. Researchers working to identify and link certain chromosomal aberrations to particular pathologies and to stages during the development and progression of particular pathologies often analyze multi-sample aCGH data in order to identify particular chromosomal aberrations statistically correlated with particular pathologies or stages and time points during the development and progression of particular pathologies. However, the large amount of data generated, as well as the often large amounts of noise and large sample variations, result in researchers relying on automated data-analysis techniques in order to identify particular aberrations correlated with pathologies and with stages of development and progression of pathologies. Currently available CGH-data and aCGH-data analysis systems do not automatically identify, in a statistically meaningful fashion, those chromosomal DNA aberrations most significantly correlated with multiple samples in multi-sample aCGH data sets. Researchers, diagnosticians, and developers of CGH and aCGH techniques, instruments, and data analysis programs have recognized the need for automated methods for detecting statistically meaningful, common aberrations from multi-sample data sets.

### SUMMARY OF THE INVENTION

Various embodiments of the present invention are directed to methods and systems for automated detection of aberrations common to multiple samples within a multi-sample comparative genomic hybridization (“CGH”) or an array-based CGH (“aCGH”) data set. Any of various aberration-calling techniques are used to identify aberrant intervals within each of the samples of the multi-sample data set. A set of candidate intervals is constructed to include unique aberrant intervals identified by the aberration-calling technique, as well as unique two-way intersections of the identified aberrant intervals. Two scores indicating the statistical significance of each candidate interval with respect to each sample are next assigned to each candidate-interval/sample pair. Then, at least one cumulative, significance score is assigned to each candidate interval based on scores assigned to the candidate-interval/sample pairs that include the candidate interval. The most statistically significant candidate intervals may be selected based on the at least one cumulative, significance score assigned to each candidate interval. More general embodiments of the present invention are directed to identifying subsequences common to sequence-based samples in multi-sample data sets.

### BRIEF DESCRIPTION OF THE DRAWINGS

FIG. 1 shows the chemical structure of a small, four-subunit, single-chain oligonucleotide.

FIG. 2 shows a symbolic representation of a short stretch of double-stranded DNA.

FIG. 3 illustrates construction of a protein based on the information encoded in a gene.

FIG. 4 shows a hypothetical set of chromosomes for a very simple, hypothetical organism.

FIG. 5 shows examples of gene deletion and gene amplification in the context of the hypothetical genome shown in FIG. 4.

FIGS. 6-7 illustrate detection of gene amplification by CGH.

FIGS. 8-9 illustrate detection of gene deletion by CGH.

FIGS. 10-12 illustrate microarray-based CGH.

FIG. 13 illustrates one method for identifying and ranking intervals and removing redundancies from lists of intervals identified as probable deletions or amplifications.

FIG. 14 illustrates the general problem domain to which method and system embodiments of the present invention are directed.

FIGS. 15A-B illustrate an aberrant interval within a chromosome.

FIGS. 16A-B illustrate a set of aberrant intervals associated with a particular chromosome or genome.

FIG. 17 illustrates, using the illustration conventions previously used in FIG. 14, a data set resulting from CGH or aCGH analysis of each of n samples S₁-Sₙ of a multi-sample CGH or aCGH data set.

FIGS. 18A-E illustrate selection of a set of candidate intervals with respect to a multi-sample CGH or aCGH data set, for each sample of which aberrant intervals have been identified.

FIG. 19 shows an illustration of the per-sample statistical scores generated for each candidate-interval/sample pair.

FIGS. 20A-B illustrate computation of a context-based statistical score.

FIG. 21 illustrates computation of a cumulative significance score for each candidate interval.

FIG. 22 illustrates remaining steps, following preparation of the 2-dimensional arrays of per-sample statistical scores discussed with reference to FIG. 19, of a process for identifying statistically significant candidate intervals that represents on embodiment of the present invention.

FIGS. 23A-B shows a t-test probability distribution f(t).

FIG. 24 illustrates an alternative method for computing a cumulative significance score for a candidate interval.

FIGS. 25A-F show control-flow diagrams that illustrate a number of steps in various embodiments of the present invention.

### DETAILED DESCRIPTION OF THE INVENTION

Embodiments of the present invention are directed to for automated detection of aberrations common to multiple samples within a multi-sample comparative genomic hybridization (“CGH”) or an array-based CGH (“aCGH”) data set. Commonly, CGH and aCGH data sets are analyzed using aberration-calling methods in order to determine those array-probe-complementary chromosome subsequences that have abnormal copy numbers with respect to a control genome. Abnormal copy numbers may include amplification of chromosome subsequences and deletion of chromosome subsequences with respect to a normal genome, or to increased or decreased copies of entire chromosomes. In a first subsection, below, a discussion of array-based comparative genomic hybridization methods and interval-based aberration-calling methods for analyzing aCGH data sets is provided. In a second subsection, embodiments of the present invention are discussed. When the term acronym CGH is used without being paired with the acronym aCGH in the following discussion, CGH is meant to include both traditional comparative genomic hybridization as well as array-based comparative genomic hybridization.

### Array-Based Comparative Genomic Hybridization and Interval-Based aCGH Data Analysis

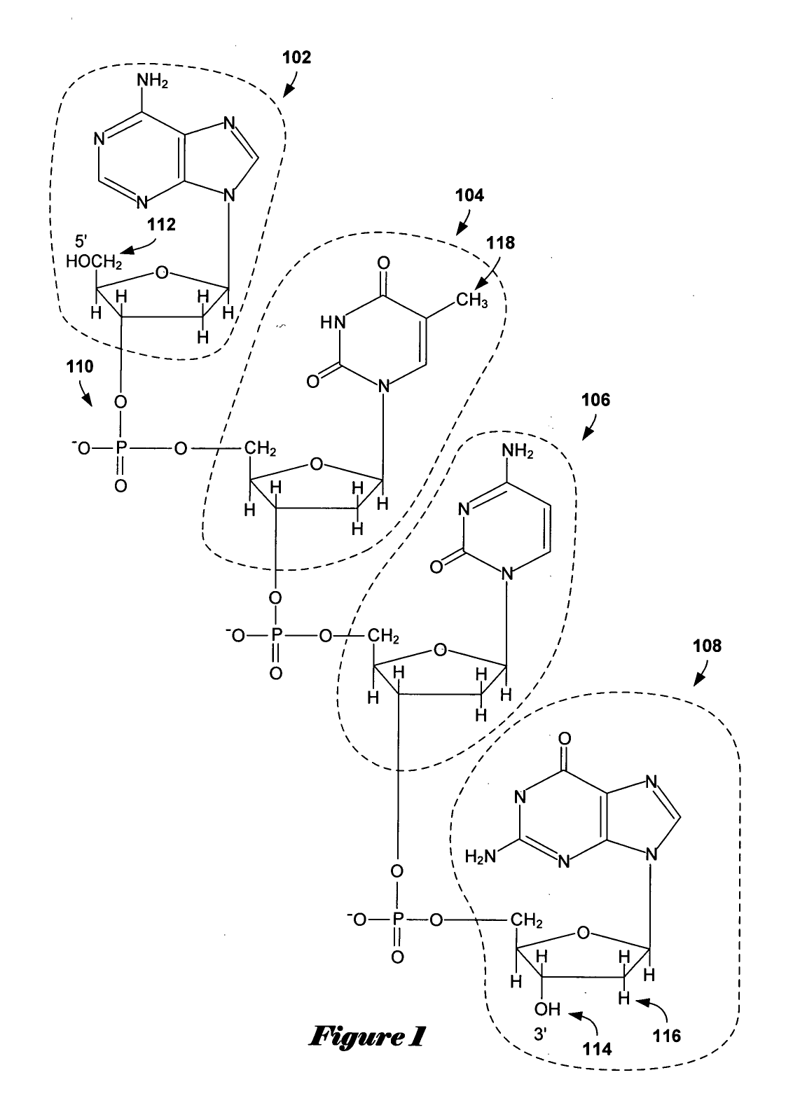

Prominent information-containing biopolymers include deoxyribonucleic acid (“DNA”), ribonucleic acid (“RNA”), including messenger RNA (“mRNA”), and proteins. FIG. 1 shows the chemical structure of a small, four-subunit, single-chain oligonucleotide, or short DNA polymer. The oligonucleotide shown in FIG. 1 includes four subunits: (1) deoxyadenosine 102, abbreviated “A”; (2) deoxythymidine 104, abbreviated “T”; (3) deoxycytodine 106, abbreviated “C”; and (4) deoxyguanosine 108, abbreviated “G.” Each subunit 102, 104, 106, and 108 is generically referred to as a “deoxyribonucleotide,” and consists of a purine, in the case of A and G, or pyrimidine, in the case of C and T, covalently linked to a deoxyribose. The deoxyribonucleotide subunits are linked together by phosphate bridges, such as phosphate 110. The oligonucleotide shown in FIG. 1, and all DNA polymers, is asymmetric, having a 5′ end 112 and a 3′ end 114, each end comprising a chemically active hydroxyl group. RNA is similar, in structure, to DNA, with the exception that the ribose components of the ribonucleotides in RNA have a 2′ hydroxyl instead of a 2′ hydrogen atom, such as 2′ hydrogen atom 116 in FIG. 1, and include the ribonucleotide uridine, similar to thymidine but lacking the methyl group 118, instead of a ribonucleotide analog to deoxythymidine. The RNA subunits are abbreviated A, U, C, and G.

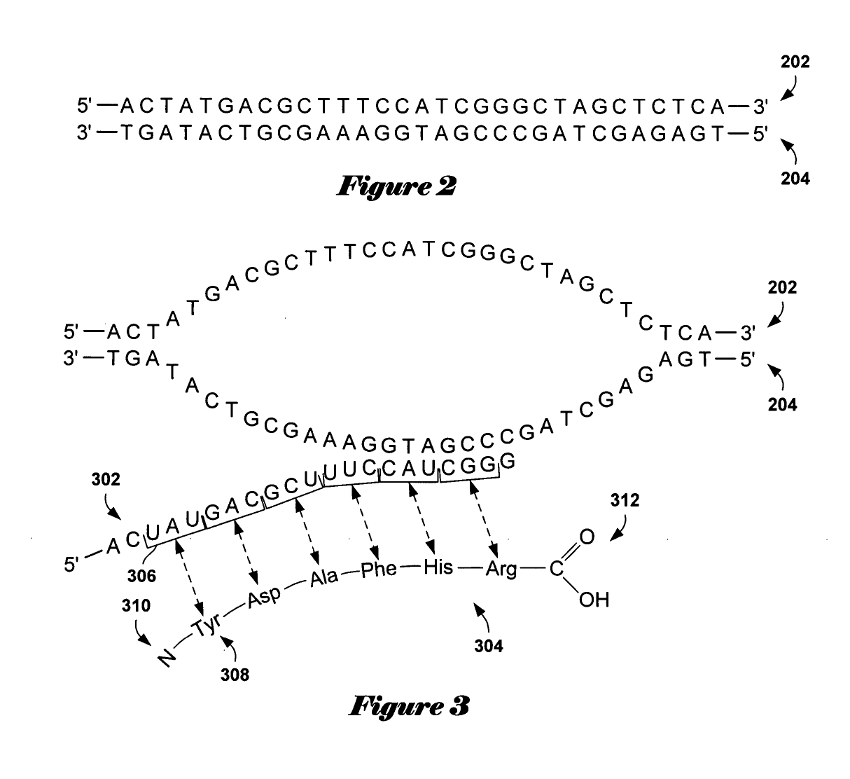

In cells, DNA is generally present in double-stranded form, in the familiar DNA-double-helix form. FIG. 2 shows a symbolic representation of a short stretch of double-stranded DNA. The first strand 202 is written as a sequence of deoxyribonucleotide abbreviations in the 5′ to 3′ direction and the complementary strand 204 is symbolically written in 3′ to 5′ direction. Each deoxyribonucleotide subunit in the first strand 202 is paired with a complementary deoxyribonucleotide subunit in the second strand 204. In general, a G in one strand is paired with a C in a complementary strand, and an A in one strand is paired with a T in a complementary strand. One strand can be thought of as a positive image, and the opposite, complementary strand can be thought of as a negative image, of the same information encoded in the sequence of deoxyribonucleotide subunits.

A gene is a subsequence of deoxyribonucleotide subunits within one strand of a double-stranded DNA polymer. One type of gene can be thought of as an encoding that specifies, or a template for, construction of a particular protein. FIG. 3 illustrates construction of a protein based on the information encoded in a gene. In a cell, a gene is first transcribed into single-stranded mRNA. In FIG. 3, the double-stranded DNA polymer composed of strands 202 and 204 has been locally unwound to provide access to strand 204 for transcription machinery that synthesizes a single-stranded mRNA 302 complementary to the gene-containing DNA strand. The single-stranded mRNA is subsequently translated by the cell into a protein polymer 304, with each three-ribonucleotide codon, such as codon 306, of the mRNA specifying a particular amino acid subunit of the protein polymer 304. For example, in FIG. 3, the codon “UAU” 306 specifies a tyrosine amino-acid subunit 308. Like DNA and RNA, a protein is also asymmetrical, having an N-terminal end 310 and a carboxylic acid end 312. Other types of genes include genomic subsequences that are transcribed to various types of RNA molecules, including catalytic RNAs, iRNAs, siRNAs, rRNAs, and other types of RNAs that serve a variety of functions in cells, but that are not translated into proteins. Furthermore, additional genomic sequences serve as promoters and regulatory sequences that control the rate of protein-encoding-gene expression. Although functions have not, as yet, been assigned to many genomic subsequences, there is reason to believe that many of these genomic sequences are functional. For the purpose of the current discussion, a gene can be considered to be any genomic subsequence.

In eukaryotic organisms, including humans, each cell contains a number of extremely long, DNA-double-strand polymers called chromosomes. Each chromosome can be thought of, abstractly, as a very long deoxyribonucleotide sequence. Each chromosome contains hundreds to thousands of subsequences, many subsequences corresponding to genes. The exact correspondence between a particular subsequence identified as a gene, in the case of protein-encoding genes, and the protein or RNA encoded by the gene can be somewhat complicated, for reasons outside the scope of the present invention. However, for the purposes of describing embodiments of the present invention, a chromosome may be thought of as a linear DNA sequence of contiguous deoxyribonucleotide subunits that can be viewed as a linear sequence of DNA subsequences. In certain cases, the subsequences are genes, each gene specifying a particular protein or RNA. Amplification and deletion of any DNA subsequence or group of DNA subsequences can be detected by comparative genomic hybridization, regardless of whether or not the DNA subsequences correspond to protein-sequence-specifying genes, to DNA subsequences specifying various types of RNAs, or to other regions with defined biological roles. The term “gene” is used in the following as a notational convenience, and should be understood as simply an example of a “biopolymer subsequence.” Similarly, although the described embodiments are directed to analyzing DNA chromosomal subsequences extracted from diseased tissues for amplification and deletion with respect to control tissues, the sequences of any information-containing biopolymer are analyzable by methods of the present invention. Therefore, the term “chromosome,” and related terms, are used in the following as a notational convenience, and should be understood as an example of a biopolymer or biopolymer sequence. In summary, a genome, for the purposes of describing the present invention, is a set of sequences. Genes are considered to be subsequences of these sequences. Comparative genomic hybridization techniques can be used to determine changes in copy number of any set of genes of any one or more chromosomes in a genome.

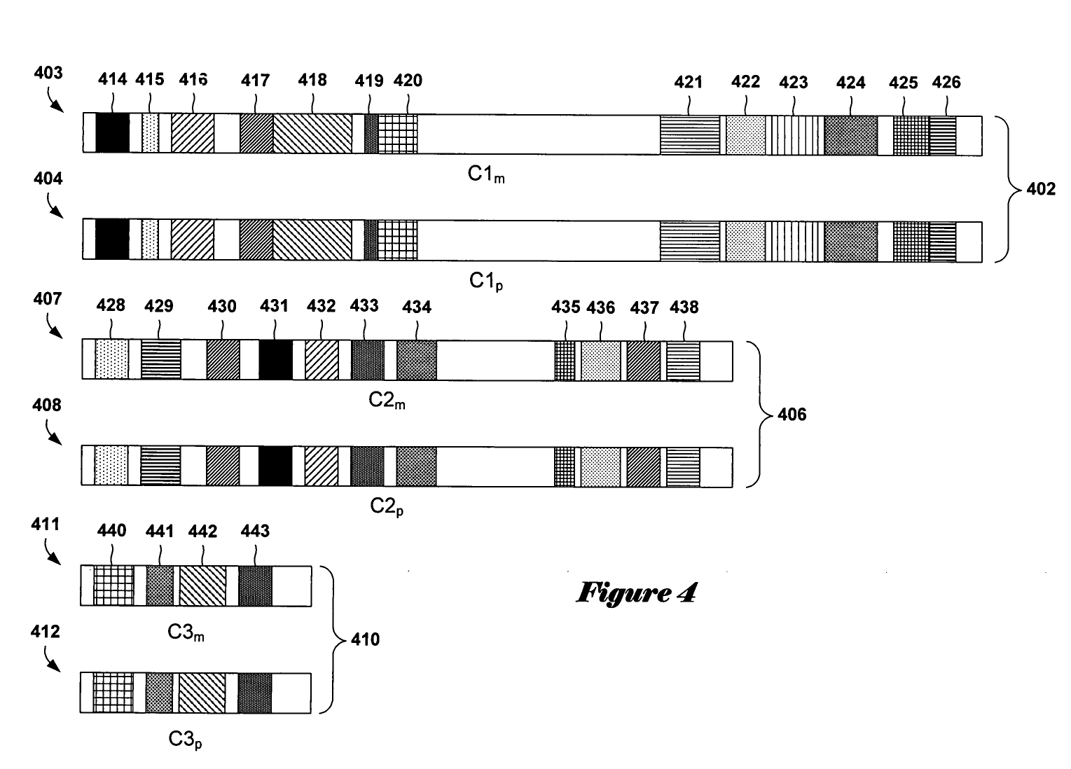

FIG. 4 shows a hypothetical set of chromosomes for a very simple, hypothetical organism. The hypothetical organism includes three pairs of chromosomes 402, 406, and 410. Each chromosome in a pair of chromosomes is similar, generally having identical genes at identical positions along the lines of the chromosome. In FIG. 4, each gene is represented as a subsection of the chromosome. For example, in the first chromosome 403 of the first chromosome pair 402, 13 genes are shown, 414-426.

As shown in FIG. 4, the second chromosome 404 of the first pair of chromosomes 402 includes the same genes, at the same positions, as the first chromosome. Each chromosome of the second pair of chromosomes 406 includes eleven genes 428-438, and each chromosome of the third pair of chromosomes 410 includes four genes 440-443. In a real organism, there are generally many more chromosome pairs, and each chromosome includes many more genes. However, the simplified, hypothetical genome shown in FIG. 4 is suitable for describing embodiments of the present invention. Note that, in each chromosome pair, one chromosome is originally obtained from the mother of the organism, and the other chromosome is originally obtained from the father of the organism. Thus, the chromosomes of the first chromosome pair 402 are referred to as chromosome “C1ₘ” and “C1ₚ”. While, in general, each chromosome of a chromosome pair has the same genes positioned at the same location along the length of the chromosome, the genes inherited from one parent may differ slightly from the genes inherited from the other parent. Different versions of a gene are referred to as alleles. Common differences include single-deoxyribonucleotide-subunit substitutions at various positions within the DNA subsequence corresponding to a gene. Less frequent differences include translocations of genes to different positions within a chromosome or to a different chromosome, a different number of repeated copies of a gene, and other more substantial differences.

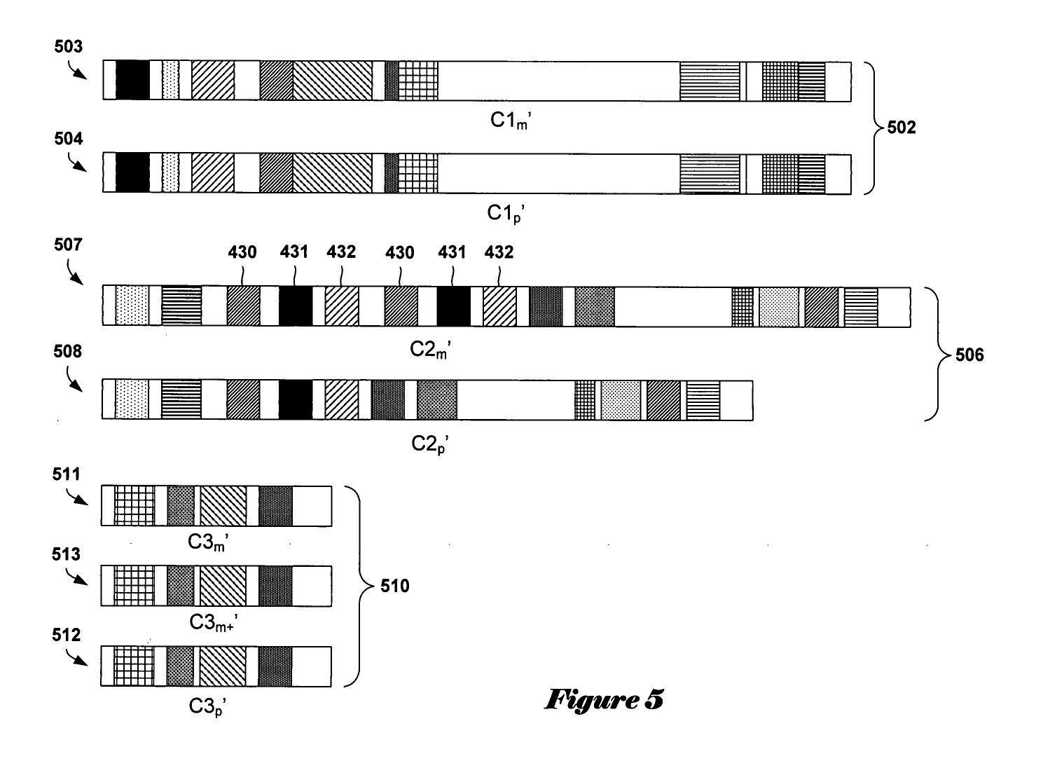

Although differences between genes and mutations of genes may be important in the predisposition of cells to various types of cancer, and related to cellular mechanisms responsible for cell transformation, cause-and-effect relationships between different forms of genes and pathological conditions are often difficult to elucidate and prove, and are very often indirect. However, other genomic abnormalities are more easily associated with pre-cancerous and cancerous tissues. Two such prominent types of genomic aberrations include gene amplification and gene deletion. FIG. 5 shows examples of gene deletion and gene amplification in the context of the hypothetical genome shown in FIG. 4. First, both chromosomes C1ₘ′ 503 and chromosome C1ₚ 504 of the variant, or abnormal, first chromosome pair 502 are shorter than the corresponding wild-type chromosomes C1ₘ and C1ₚ in the first pair of chromosomes 402 shown in FIG. 4. This shortening is due to deletion of genes 422, 423, and 424, present in the wild-type chromosomes 403 and 404, but absent in the variant chromosomes 503 and 504. This is an example of a double, or homozygous-gene-deletion. Small scale variations of DNA copy numbers can also exist in normal cells. These can have phenotypic implications, and can also be measured by CGH methods and analyzed by the methods of the present invention.

Generally, deletion of multiple, contiguous genes is observed, corresponding to the deletion of a substantial subsequence from the DNA sequence of a chromosome. Much smaller subsequence deletions may also be observed, leading to abnormal and often nonfunctional genes. A gene deletion may be observed in only one of the two chromosomes of a chromosome pair, in which case a gene deletion is referred to as being hemizygous.

A second chromosomal abnormality in the altered genome shown in FIG. 5 is duplication of genes 430, 431, and 432 in the maternal chromosome C2ₘ′ 507 of the second chromosome pair 506. Duplication of one or more contiguous genes within a chromosome is referred to as gene amplification. In the example altered genome shown in FIG. 5, the gene amplification in chromosome C2ₘ′ is heterozygous, since gene amplification does not occur in the other chromosome of the pair C2ₚ′ 508. The gene amplification illustrated in FIG. 5 is a two-fold amplification, but three-fold and higher-fold amplifications are also observed. An extreme chromosomal abnormality is illustrated with respect to the third chromosome pair (410 in FIG. 4). In the altered genome illustrated in FIG. 5, the entire maternal chromosome 511 has been duplicated from a third chromosome 513, creating a chromosome triplet 510 rather than a chromosome pair. This three-chromosome phenomenon is referred to as a trisomy. The trisomy shown in FIG. 5 is an example of heterozygous gene amplification, but it is also observed that both chromosomes of a chromosome pair may be duplicated, higher-order amplification of chromosomes may be observed, and heterozygous and hemizygous deletions of entire chromosomes may also occur, although organisms with such genetic deletions are generally not viable.

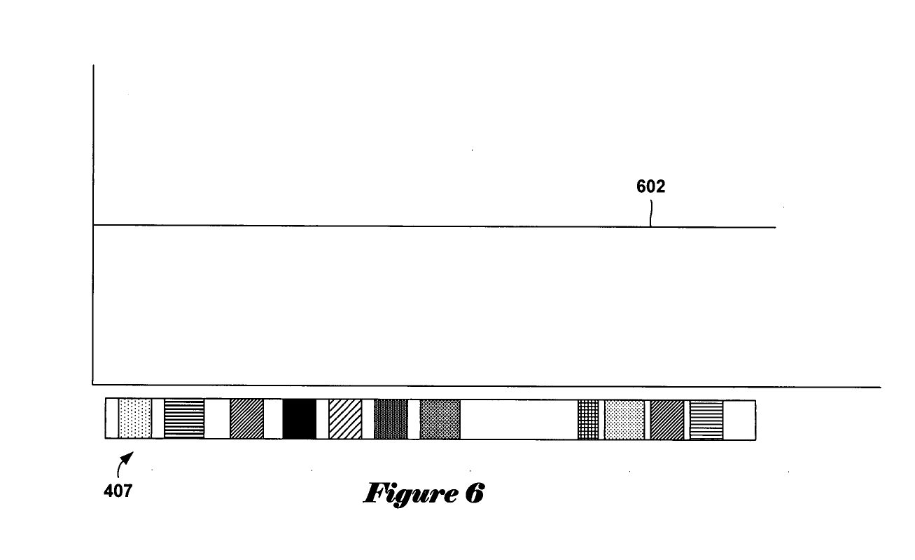

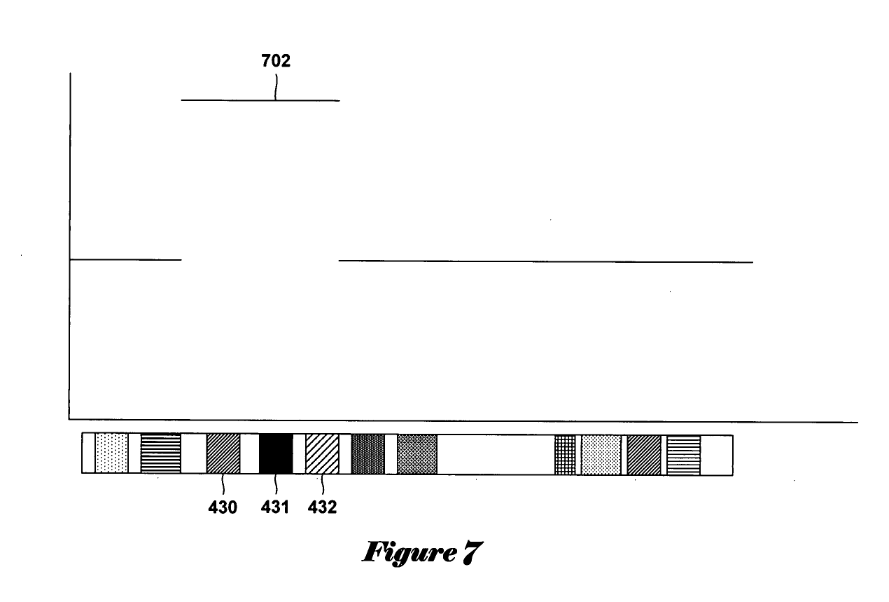

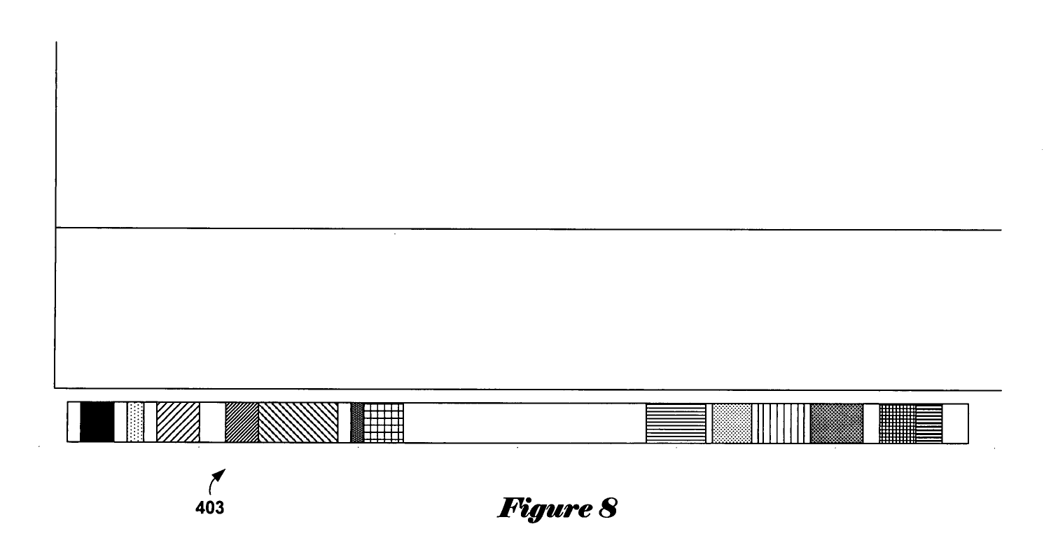

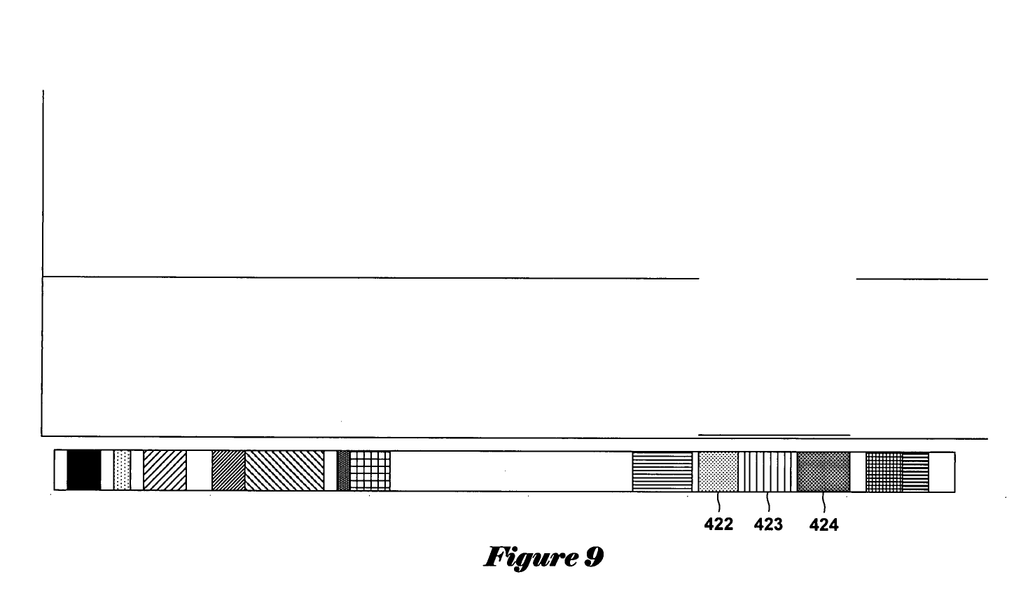

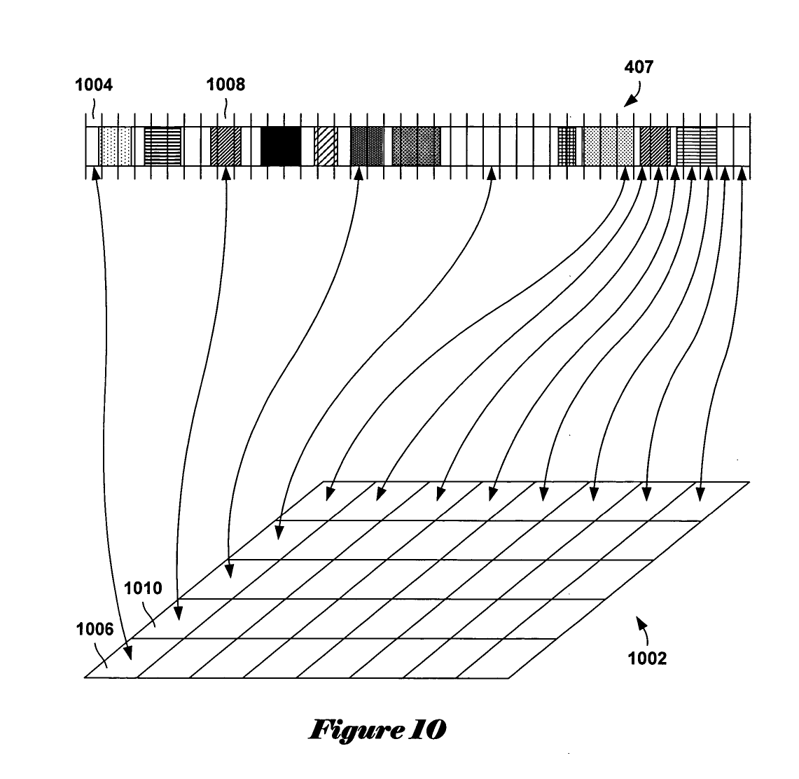

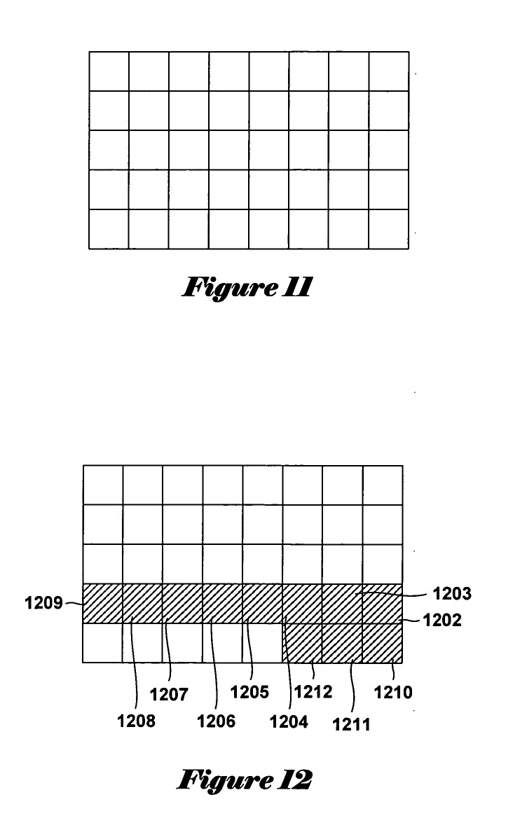

Changes in the number of gene copies, either by amplification or deletion, can be detected by comparative genomic hybridization (“CGH”) techniques. FIGS. 6-7 illustrate detection of gene amplification by CGH, and FIGS. 8-9 illustrate detection of gene deletion by CGH. CGH involves analysis of the relative level of binding of chromosome fragments from sample tissues to single-stranded, normal chromosomal DNA. The tissues-sample fragments hybridize to complementary regions of the normal, single-stranded DNA by complementary binding to produce short regions of double-stranded DNA. Hybridization occurs when a DNA fragment is exactly complementary, or nearly complementary, to a subsequence within the single-stranded chromosomal DNA. In FIG. 6, and in subsequent figures, one of the hypothetical chromosomes of the hypothetical wild-type genome shown in FIG. 4 is shown below the x axis of a graph, and the level of sample fragment binding to each portion of the chromosome is shown along the y axis. In FIG. 6, the graph of fragment binding is a horizontal line 602, indicative of generally uniform fragment binding along the length of the chromosome 407. In an actual experiment, uniform and complete overlap of DNA fragments prepared from tissue samples may not be possible, leading to discontinuities and non-uniformities in detected levels of fragment binding along the length of a chromosome. However, in general, fragments of a normal chromosome isolated from normal tissue samples should, at least, provide a binding-level trend approaching a horizontal line, such as line 602 in FIG. 6. By contrast, CGH data for fragments prepared from the sample genome illustrated in FIG. 5 should generally show an increased binding level for those genes amplified in the abnormal genotype.

FIG. 7 shows hypothetical CGH data for fragments prepared from tissues with the abnormal genotype illustrated in FIG. 5. As shown in FIG. 7, an increased binding level 702 is observed for the three genes 430-432 that are amplified in the altered genome. In other words, the fragments prepared from the altered genome should be enriched in those gene fragments from genes which are amplified. Moreover, in quantitative CGH, the relative increase in binding should be reflective of the increase in a number of copies of particular genes.

FIG. 8 shows hypothetical CGH data for fragments prepared from normal tissue with respect to the first hypothetical chromosome 403. Again, the CGH-data trend expected for fragments prepared from normal tissue is a horizontal line indicating uniform fragment binding along the length of the chromosome. By contrast, the homozygous gene deletion in chromosomes 503 and 504 in the altered genome illustrated in FIG. 5 should be reflected in a relative decrease in binding with respect to the deleted genes. FIG. 9 illustrates hypothetical CGH data for DNA fragments prepared from the hypothetical altered genome illustrated in FIG. 5 with respect to a normal chromosome from the first pair of chromosomes (402 in FIG. 4). As seen in FIG. 9, no fragment binding is observed for the three deleted genes 422, 423, and 424.

CGH data may be obtained by a variety of different experimental techniques. In one technique, DNA fragments are prepared from tissue samples and labeled with a particular chromophore. The labeled DNA fragments are then hybridized with single-stranded chromosomal DNA from a normal cell, and the single-stranded chromosomal DNA then visually inspected via microscopy to determine the intensity of light emitted from labels associated with hybridized fragments along the length of the chromosome. Areas with relatively increased intensity reflect regions of the chromophore amplified in the corresponding tissue chromosome, and regions of decreased emitted signal indicate deleted regions in the corresponding tissue chromosome. In other techniques, normal DNA fragments labeled with a first chromophore are competitively hybridized to a normal single-stranded chromosome with fragments isolated from abnormal tissue, labeled with a second chromophore. Relative binding of normal and abnormal fragments can be detected by ratios of emitted light at the two different intensities corresponding to the two different chromophore labels.

A third type of CGH is referred to as microarray-based CGH (“aCGH”). FIGS. 10-11 illustrate microarray-based CGH. In FIG. 10, synthetic probe oligonucleotides having sequences equal to contiguous subsequences of hypothetical chromosome 407 and/or 408 in the hypothetical, normal genome illustrated in FIG. 4 are prepared as features on the surface of the microarray 1002. For example, a synthetic probe oligonucleotide having the sequence of one strand of the region 1004 of chromosome 407 and/or 408 is synthesized in feature 1006 of the hypothetical microarray 1002. Similarly, an oligonucleotide probe corresponding to subsequence 1008 of chromosome 407 and 408 is synthesized to produce the oligonucleotide probe molecules of feature 1010 of microarray 1002. In actual cases, probe molecules may be much shorter relative to the length of the chromosome, and multiple, different, overlapping and non-overlapping probes/features may target a particular gene. Nonetheless, there is generally a definite, well-known correspondence between microarray features and genes, with the term “genes,” as discussed above, referring broadly to any biopolymer subsequence of interest. There are many different types of aCGH procedures, including the two-chromophore procedure described above, single-chromophore CGH on single-nucleotide-polymorphism arrays, bacterial-artificial-chromosome-based arrays, and many other types of aCGH procedures. The present invention is applicable to all aCGH variants. For each variant, data obtained by comparing signals generated by the variant with signals generated by a normal reference generally constitute a starting point for aCGH analysis. When single-dye technologies are used, multiple microarray-based procedures may be needed for aCGH analysis.

The microarray may be exposed to sample solutions containing fragments of DNA. In one version of aCGH, an array may be exposed to fragments, labeled with a first chromophore, prepared from potentially abnormal tissue as well as to fragments, labeled with a second chromophore, prepared from a normal or control tissue. The normalized ratio of signal emitted from the first chromophore versus signal emitted from the second chromophore for each feature provides a measure of the relative abundance of the portion of the normal chromosome corresponding to the feature in the abnormal tissue versus the normal tissue. In the hypothetical microarray 1002 of FIG. 10, each feature corresponds to a different interval along the length of chromosome 407 and 408 in the hypothetical wild-type genome illustrated in FIG. 4. When fragments prepared from a normal tissue sample, labeled with a first chromophore, and DNA fragments prepared from normal tissue labeled with the second chromophore, are both hybridized to the hypothetical microarray shown in FIG. 10, and normalized intensity ratios for light emitted by the first and second chromophores are determined, the normalized ratios for all features should be relatively uniformly equal to one.

FIG. 11 represents an aCGH data set for two normal, differentially labeled samples hybridized to the hypothetical microarray shown in FIG. 10. The normalized ratios of signal intensities from the first and second chromophores are all approximately unity, shown in FIG. 11, by log ratios for all features of the hypothetical microarray 1002 displayed in the same color. By contrast, when DNA fragments isolated from tissues having the abnormal genotype, illustrated in FIG. 5, labeled with a first chromophore are hybridized to the microarray, and DNA fragments prepared from normal tissue, labeled with a second chromophore, are hybridized to the microarray, then the ratios of signal intensities of the first chromophore versus the second chromophore vary significantly from unity in those features containing probe molecules equal to, or complementary to, subsequences of the amplified genes 430, 431, and 432. As shown in FIG. 12, increase in the ratio of signal intensities from the first and second chromophores, indicated by darkened features, are observed in those features 1202-1212 with probe molecules equal to, or complementary to, subsequences spanning the amplified genes 430, 431, and 432. Similarly, a decrease in signal intensity ratios indicates gene deletion in the abnormal tissues.

Microarray-based CGH data obtained from well-designed microarray experiments provide a relatively precise measure of the relative or absolute number of copies of genes in cells of a sample tissue. Sets of aCGH data obtained from pre-cancerous and cancerous tissues at different points in time can be used to monitor genome instability in particular pre-cancerous and cancerous tissues. Quantified genome instability can then be used to detect and follow the course of particular types of cancers. Moreover, quantified genome instabilities in different types of cancerous tissue can be compared in order to elucidate common chromosomal abnormalities, including gene amplifications and gene deletions, characteristic of different classes of cancers and pre-cancerous conditions, and to design and monitor the effectiveness of drug, radiation, and other therapies used to treat cancerous or pre-cancerous conditions in patients. Unfortunately, biological data can be extremely noisy, with the noise obscuring underlying trends and patterns. Scientists, diagnosticians, and other professionals have therefore recognized a need for statistical methods for normalizing and analyzing aCGH data, in particular, and CGH data in general, in order to identify signals and patterns indicative of chromosomal abnormalities that may be obscured by noise arising from many different kinds of experimental and instrumental variations.

One approach to ameliorating the effects of high noise levels in CGH data involves normalizing sample-signal data by using control signal data. Features can be included in a microarray to respond to genome targets known to be present at well-defined multiplicities in both sample genome and the control genome. Control signal data can be used to estimate an average ratio for abnormal-genome-signal intensities to control-genome-signal intensities, and each abnormal-genome signal can be multiplied by the inverse of the estimated ratio, or normalization constant, to normalize each abnormal-genome signal to the control-genome signals. Another approach is to compute the average signal intensity for the abnormal-genome sample and the average signal intensity for the control-genome sample, and to compute a ratio of averages for abnormal-genome-signal intensities to control-genome-signal intensities based on averaged signal intensities for both samples.

In a more general case, an aCGH array may contain a number of different features, each feature generally containing a particular type of probe, each probe targeting a particular chromosomal DNA subsequence indexed by index k that represents a genomic location. A subsequence indexed by index k is referred to as “subsequence k.” One can define the signal generated for subsequence k as the sum of the normalized log-ratio signals from the different probes targeting subsequence k divided by the number of probes targeting subsequence k or, in other words, the average log-ratio signal value generated from the probes targeting subsequence k, as follows:

$$C ( k ) = \frac{{\sum }_{b ∈ \{ features containing probes for k \}} C ( b )}{{num\_features}_{k}}$$

where num_featuresₖ is the number of features that target the subsequence k;

C(b) is the normalized log-ratio signal measured for feature b,

$$C ( b ) = {log ( \frac{{J}_{red}}{{J}_{green}} )}_{b} - \frac{{\sum }_{i ∈ \{ allfeatures \}} {log ( \frac{{J}_{red}}{{J}_{green}} )}_{i}}{num\_features} ; and {( \frac{{J}_{red}}{{J}_{green}} )}_{i}$$

is the ratio of measured red signal J_{red} to measured green signal J_{green} for feature i. In the case where a single probe targets a particular subsequence, k, no averaging is needed.

To re-emphasize, each aCGH data point is generally a log ratio of signals read from a particular feature of a microarray that contains probes targeting a particular subsequence, the log-ratio of signals representing the ratio of signals emitted from a first label used to label fragments of a genome sample to a signal generated from a second label used to label fragments of a normal, control genome. Both the sample-genome fragments and the normal, control fragments hybridize to normal-tissue-derived probe molecules on the microarray. A normal tissue or sample may be any tissue or sample selected as a control tissue or sample for a particular experiment. The term “normal” does not necessarily imply that the tissue or sample represents a population average, a non-diseased tissue, or any other subjective-or object classification. The sample genome may be obtained from a diseased or cancerous tissue, in order to compare the genetic state of the diseased or cancerous tissue to a normal tissue, but may also be a normal tissue.

Subsequence deletions and amplifications generally span a number of contiguous subsequences of interest, such as genes, control regions, or other identified subsequences, along a chromosome. It therefore makes sense to analyze aCGH data in a chromosome-by-chromosome fashion, statistically considering groups of consecutive subsequences along the length of the chromosome in order to more reliably detect amplification and deletion. Specifically, it is assumed that the noise of measurement is independent for each subsequence along the chromosome, and independent for distinct probes. Statistical measures are employed to identify sets of consecutive subsequences for which deletion or amplification is relatively strongly indicated. This tends to ameliorate the effects of spurious, single-probe anomalies in the data. This is an example of an aberration-calling technique, in which gene-copy anomalies appearing to be above the data-noise level are identified.

One can consider the measured, normalized, or otherwise processed signals for subsequences along the chromosome of interest to be a vector V as follows:
V={v₁, v₂, . . . , vₙ}
where vₖ=C(k)
Note that the vector, or set V, is sequentially ordered by position of subsequences along the chromosome. A statistic S is computed for each interval I of subsequences along the chromosome as follows:

$$S ( I ) = ( {\sum }_{k = i , … , j} {v}_{k} ) \cdot \frac{1}{\sqrt{j - i + 1}}$$

$$where I = \{ {v}_{i} , … , {v}_{j} \}$$

Under a null model assuming no sequence aberrations, the statistic S has a normal distribution of values with mean=0 and variance=1, independent of the number of probes included in the interval I. The statistical significance of the normalized signals for the subsequences in an interval I can be computed by a standard probability calculation based on the area under the normal distribution curve:

$$Prob ( \vert S ( I ) \vert > z ) \approx ( \frac{1}{\sqrt{2 π}} ) \frac{1}{z} {ⅇ}^{- \frac{{z}^{2}}{2}}$$

Alternatively, the magnitude of S(I) can be used as a basis for determining alteration.

It should be noted that various different interval lengths may be used, iteratively, to compute amplification and deletion probabilities over a particular biopolymer sequence. In other words, a range of interval sizes can be used to refine amplification and deletion indications over the biopolymer.

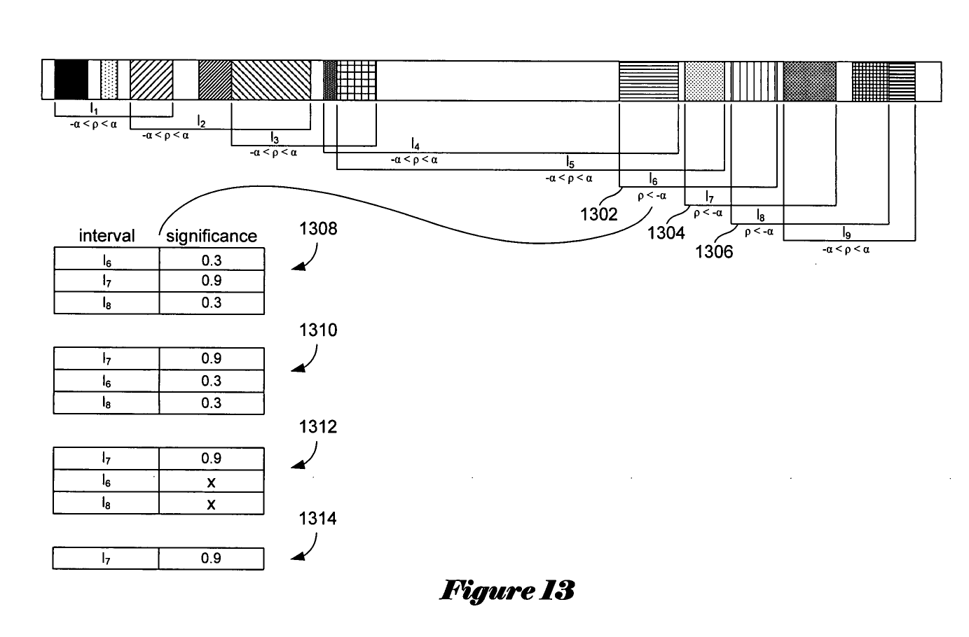

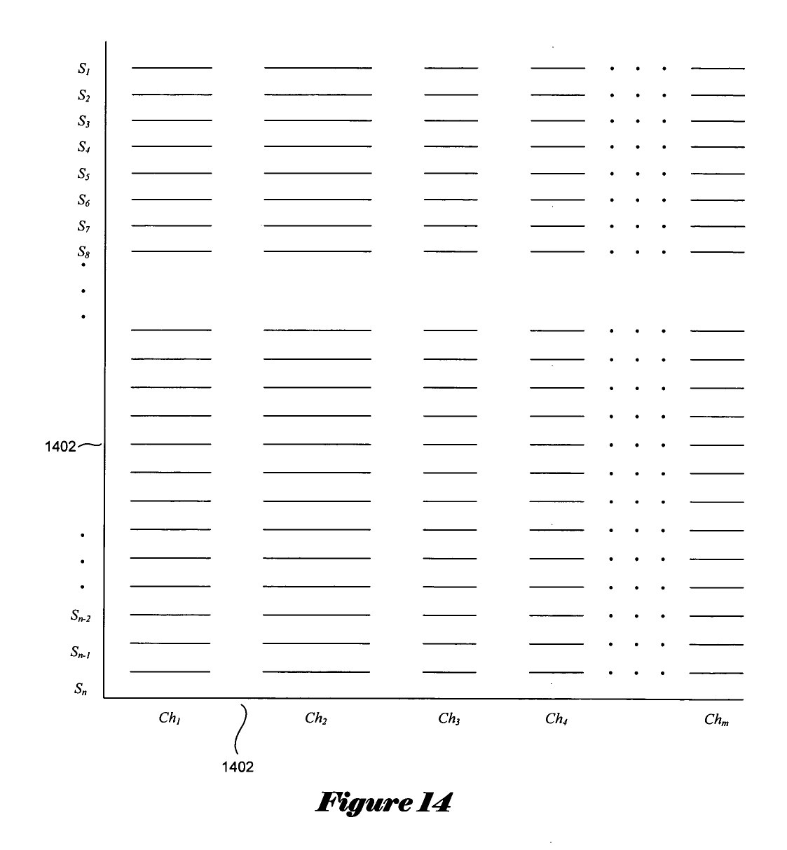

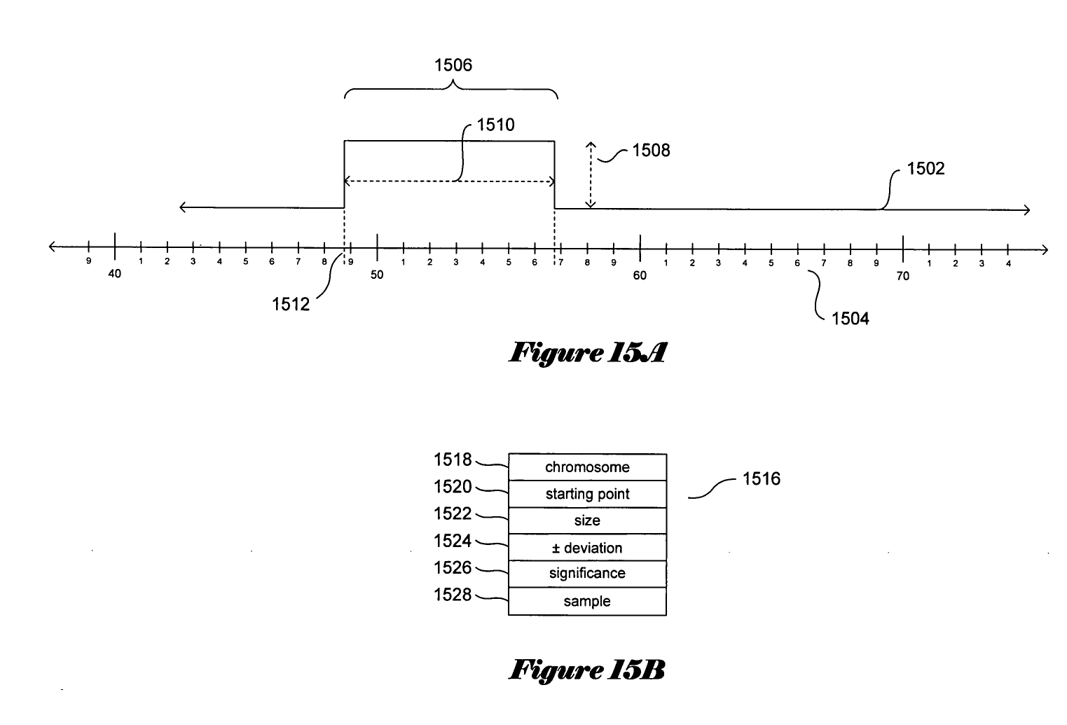

After the probabilities for the observed values for intervals are computed, those intervals with computed probabilities outside of a reasonable range of expected probabilities under the null hypothesis of no amplification or deletion are identified, and redundancies in the list of identified intervals are removed. FIG. 13 illustrates one method for identifying and ranking intervals and removing redundancies from lists of intervals identified as corresponding to probable deletions or amplifications. In FIG. 13, the intervals for which probabilities are computed along the chromosome C₁ (402 in FIG. 4) for diseased tissue with an abnormal chromosome (502 in FIG. 5) are shown. Each interval is labeled by an interval number, Iₓ, where x ranges from 1 to 9. For most intervals, the calculated probability falls within a range of probabilities consonant with the null hypothesis. In other words, neither amplification nor deletion is indicated for most of the intervals. However, for intervals I₆ 1302, I₇, 1304, and I₈, 1306, the computed probabilities fall below the range of probabilities expected for the null hypothesis, indicating potential subsequence deletion in the diseased-tissue sample. These three intervals are placed into an initial list 1308 which is ordered by the significance of the computed probability into an ordered list 1310. Note that interval I₇ 1304 exactly includes those subsequences deleted in the diseased-tissue chromosome (502 in FIG. 5), and therefore reasonably has the highest significance with respect to falling outside the probability range of the null hypothesis. Next, all intervals overlapping an interval occurring higher in the ordered list are removed, as shown in list 1312, where overlapping intervals I₆ and I₈, with less significance, are removed, as indicated by the character X placed into the significance column for the entries corresponding to intervals I₆ and I₈. The end result is a list containing a single interval 1314 that indicates the interval most likely coinciding with the deletion. The final list for real chromosomes, containing thousands of subsequences and analyzed using hundreds of intervals, may generally contain more than a single entry. Additional details regarding computation of interval scores can be found in “Efficient Calculation of Interval Scores for DNA Copy Number Data Analysis,” Lipson et al., Proceedings of RECOMB 2005, LNCS 3500, p. 83, Springer-Verlag.

### Embodiments of the Present Invention

The aberration-calling, or aberration-identifying, methods discussed in the previous subsection can be implemented in a CGH or an aCGH-data-processing system in order to provide automated identification of aberrant intervals within each sample analyzed by a CGH or aCGH technique. These methods also provide a score S(I) that may be associated with each identified aberrant interval. In general, researchers and diagnosticians analyze a large number of samples with the goal of identifying the statistically significant aberrations common to a large number of samples within a multi-sample data set. For example, chromosomal DNA samples obtained from hundreds of patients with a particular type of cancer may be analyzed by an aCGH technique with the hope of identifying a set of chromosomal regions aberrant in a large fraction of, or all of, the chromosomal DNA samples obtained from the hundreds of patients. The common aberrant chromosomal regions may then be correlated with the particular type of cancer. Identifying aberrant chromosomal regions correlated with a particular cancer or other type of pathology may lead to effective diagnostic tools for the particular type of cancer or pathology, methods for analyzing the results of various treatment strategies, and even promising molecular targets for new therapeutic agents. Unfortunately, current CGH and aCGH-data-processing methods and systems do not provide for automated identification of statistically significant, common aberrations from multi-sample data sets. Method and system embodiments of the present invention are directed to automated identification of statistically significant aberrations common to multiple samples of a multi-sample data set.

FIG. 14 illustrates the general problem domain to which method and system embodiments of the present invention are directed. In FIG. 14, the illustrated problem domain comprises n chromosomal-DNA samples labeled S₁ to Sₙ and ordered along the vertical axis 1402. Each sample includes multiple copies of m chromosomes, labeled Ch₁ to Chₘ, and shown in FIG. 14 ordered with respect to the horizontal axis 1404. The aberration-calling method described in the previous subsection, or another aberration-calling method, may be used to identify a set of aberrant intervals within each chromosome of each sample. Methods and system embodiments of the present invention employ any of various aberration-calling methods in order to generate a set of aberrant intervals for each chromosome of each sample. Although aberrant intervals are generally identified on a per-chromosome basis, aberrant intervals are considered, for purposes of describing the present invention, to be associated with an entire sample. In other words, the entire set of chromosomes in each sample may be considered to be one, large genomic DNA sequence, in which aberrant intervals are identified.

FIGS. 15A-B illustrate an aberrant interval within a chromosome. In FIG. 15A, the determined copy number is shown plotted as a step function 1502 with respect to chromosomal position 1504. The horizontal axis 1504 is incremented in mega-base (“MB”) units. Alternatively, the chromosome can be incremented in probe units, with the positions of probes along the DNA sequence serving as increments. In the current discussion, MB units and probes units are considered to be interchangeable. An aberrant interval 1506 is shown with an increased copy number, relative to a control sample, representing an amplification. The aberrant interval 1506 can be characterized by: (1) a height 1508, representing the relative increase in copy number for the aberrant chromosomal region in a sample with respect to a control; (2) a width 1510 corresponding to the length of the aberrant interval in mega-base units or probe units; and (3) a starting point 1512, designated in MB units or probe units.

FIG. 15B shows a data structure, or record, for representing an aberrant interval detected by an aberration-calling method. The data structure 1516 includes fields with numerical values that identify: (1) the chromosome in which the aberrant interval occurs 1518; (2) the starting point of the aberrant interval in MB or probe units 1520; (3) the size, or length, of the aberrant interval in MB or probe units 1522; (4) the magnitude and direction of the aberration, in copy-number units 1524; (5) a significance value 1526, such as the S(I) score discussed in the previous subsection, associated with the aberrant interval; and (6) a sample identification 1528 that indicates the chromosomal-DNA sample in which the aberration has been detected.

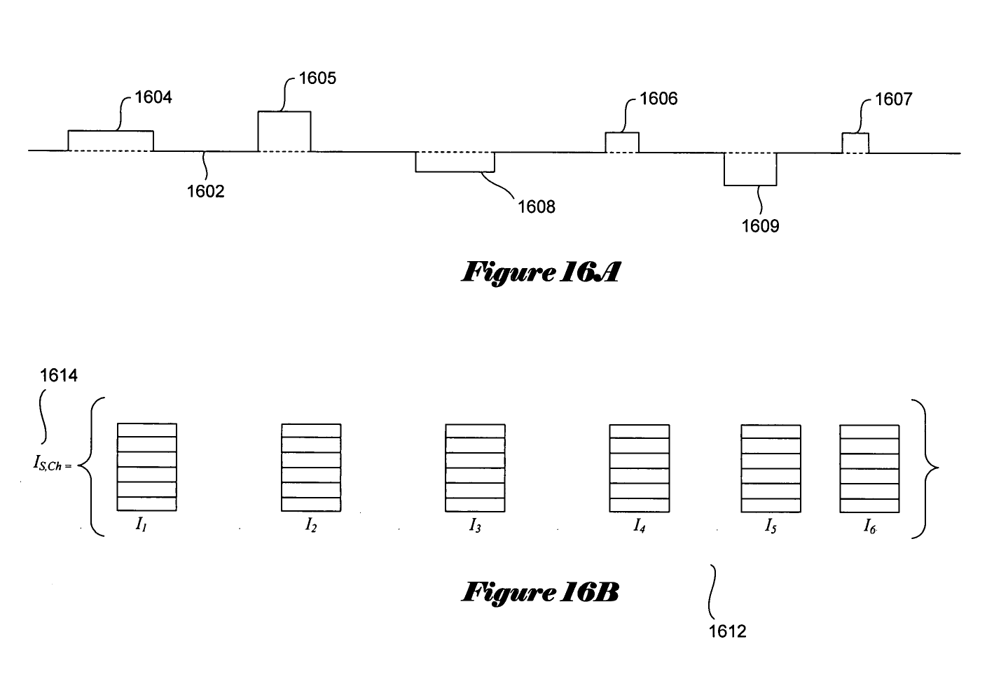

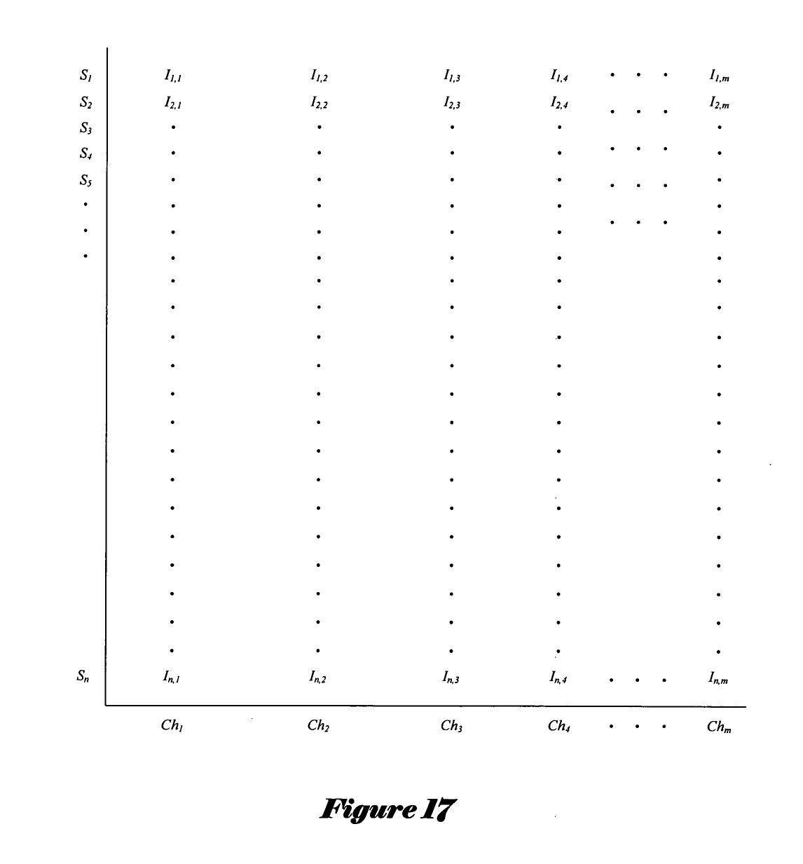

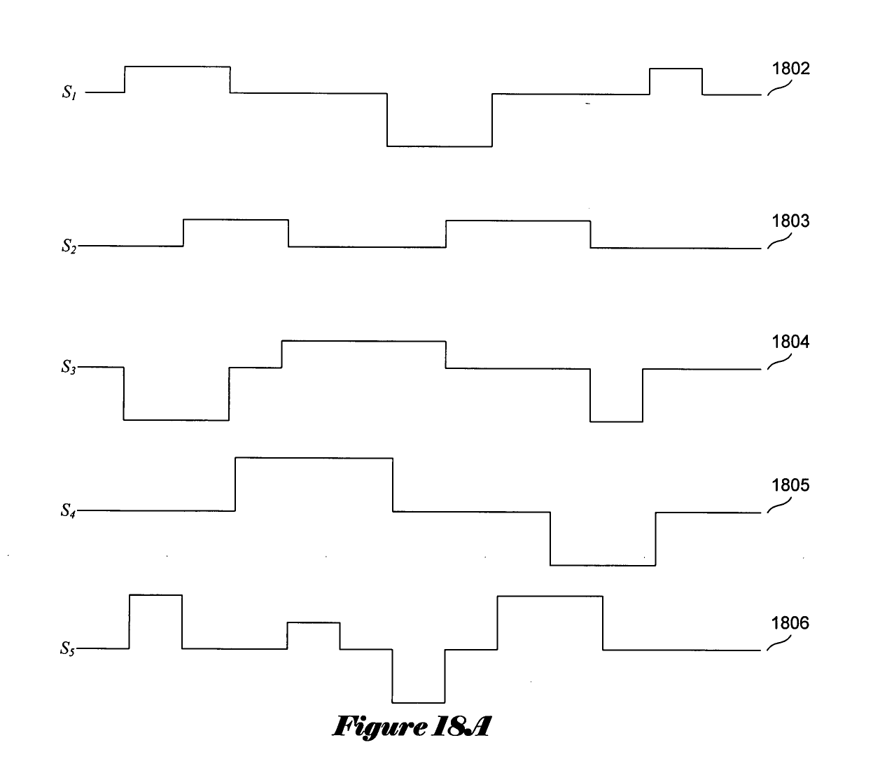

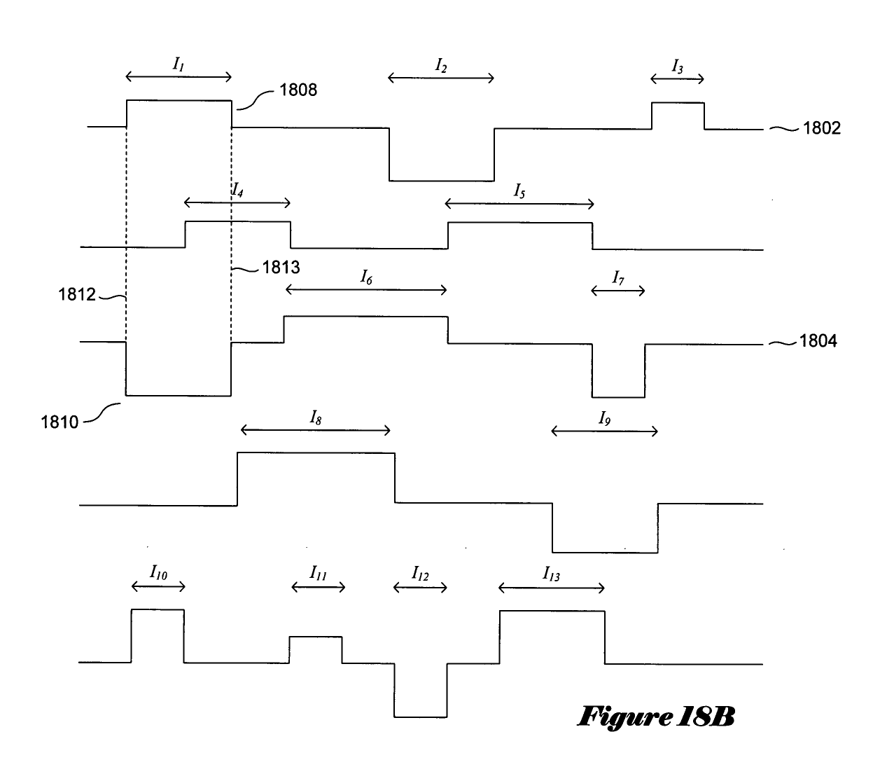

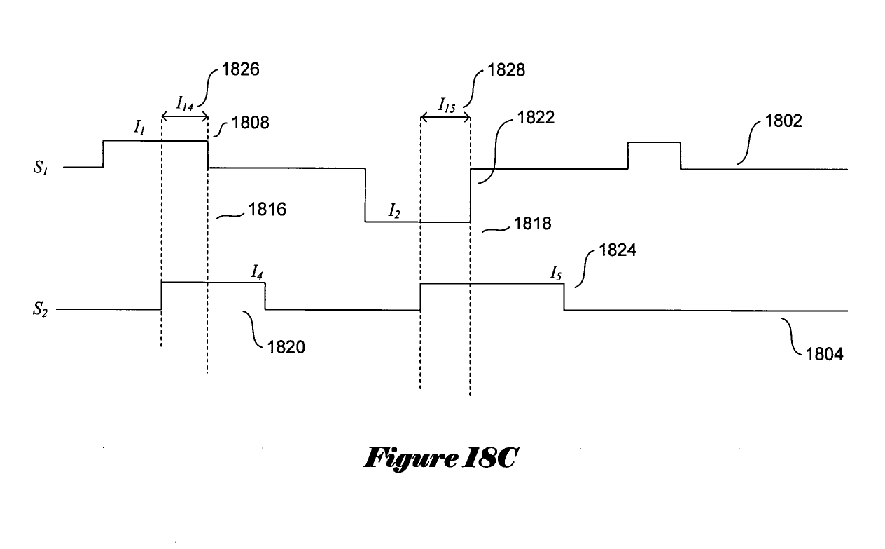

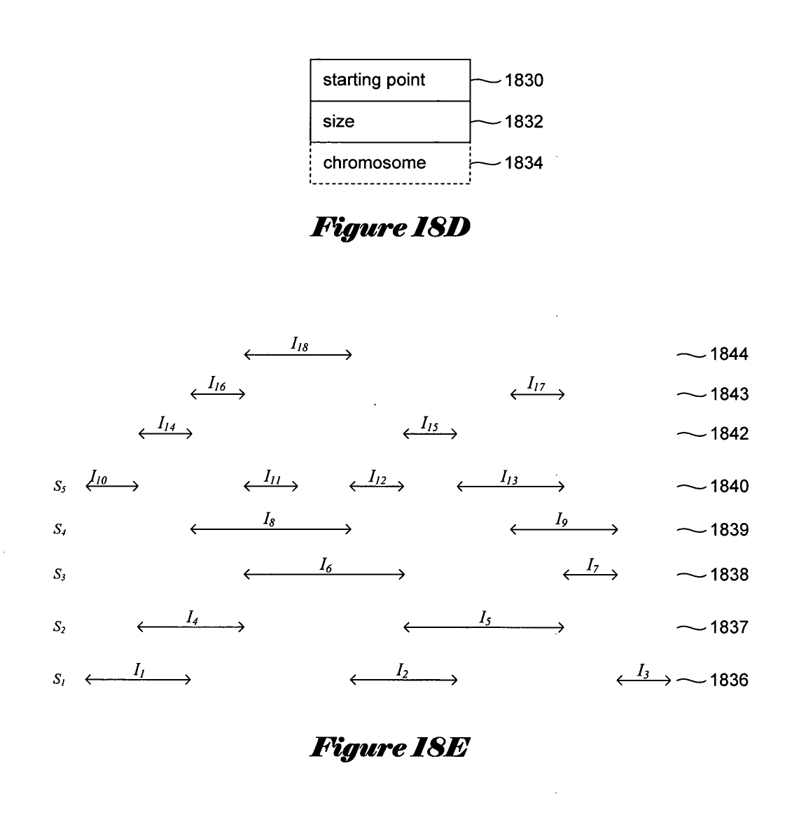

FIGS. 16A-B illustrate a set of aberrant intervals associated with a particular chromosome or genome. As shown in FIG. 16A, a chromosome or genome can be considered to be a length of normal-copy regions, such as normal-copy region 1602, interspersed with amplified regions, or amplified intervals, such as amplified intervals 1604-607, and deleted regions, or deleted intervals, such as deleted intervals 1608-1609. FIG. 16B shows a computational model for the aCGH-analyzed chromosome or genome illustrated in FIG. 16A. As shown in FIG. 16B, each of the aberrant intervals identified within the chromosome or genome can be represented by a data structure, such as the data structure shown in FIG. 15B. These data structures together compose a set of data structures 1612 that can be represented compactly by the notation I_{S,C} 1614. The subscript S represents the sample in which the aberrant interval is identified and the subscript Ch represents the chromosome in which the aberrant interval occurs.

FIG. 17 illustrates, using the illustration conventions previously used in FIG. 14, a data set resulting from CGH or aCGH analysis of each of n samples S₁-Sₙ of a multi-sample CGH or aCGH data set. As shown in FIG. 17, for each chromosome in each sample, a set of aberrant intervals I_{S,Ch} is obtained. Thus, the resulting data set can be thought of as a 2-dimensional matrix of aberrant-interval sets. Method and system embodiments of the present invention are directed to identifying particular intervals within the aberrant-interval sets I_{S,Ch} that are common to a significant number of samples within the sample set S₁-Sₙ.

FIGS. 18A-E illustrate selection of a set of candidate intervals with respect to a multi-sample CGH or aCGH data set, for each sample of which aberrant intervals have been identified. Selection of a candidate interval set is a first step in identifying statistically significant, common intervals for the multi-sample data set. FIG. 18A shows step-function-like representations of hypothetical chromosomes or genomes of a multi-sample set consisting of five samples. The step-function-like representations of the five chromosome or genomes 1802-1806 are vertically aligned with one another in FIG. 18A, to facilitate comparison of aberrant intervals.

FIG. 18B shows a first step in selecting a set of candidate intervals. Each aberrant interval of each sample is considered in turn, starting with the first aberrant interval 1808 identified in the first sample 1802. If the next considered aberrant interval is not already a member of the set of candidate intervals, the next considered aberrant interval is added to the set of candidate intervals. In FIG. 18B, the intervals are labeled I₁-I₁₃, in numerical order of their addition to the candidate interval set. The sixth aberrant interval considered in this process, aberrant interval 1810 identified in sample S₃ 1804, is not added to the set of candidate intervals because this interval exactly coincides with the first interval, I₁ 1808, as indicated in FIG. 18B by dashed lines 1812-1813. The direction and height of the intervals are not considered when comparing the next interval with the intervals already added to the set of candidate intervals. Only the starting points and lengths of aberrant intervals are considered. As a result of this first step, the set of candidate intervals includes a unique, or non-redundant, set of aberrant intervals identified in all of the samples of the multi-sample data set.

In a second step, following addition of the aberrant intervals identified by an aberration-calling method carried out on each individual sample, as discussed with reference to FIG. 18B, intersections of each possible pair of overlapping candidate intervals are identified and added to the set of candidate intervals. As with the aberrant intervals added in the first step, an intersection interval is added to the set of candidate intervals in this second step only if the intersection interval has not already been entered into the set of candidate intervals. FIG. 18C illustrates identification of two interval intersections. In FIG. 18C, the step-function-like representations of the chromosome or genome from samples S₁ 1802 and S₂ 1804 are shown vertically aligned, as in FIGS. 18A-B. The pairs of dashed lines 1816 and 1818 in FIG. 18C show that interval I₁ 1808 in Sample 1 overlaps interval I₄ 1820 in sample S₂. Similarly, interval I₂ 1822 in sample S₁ overlaps intervals I₅ 1824 in sample S₂. The regions of overlap of the two sets of intervals are considered to be intersection intervals I₁₄ 1826 and I₁₅ 1828. Because intervals I₁₄ and I₁₅ have not yet been entered into the set of candidate intervals, the intersection intervals I₁₄ and I₁₅ are entered as the 14^{th} and 15^{th} intervals in the set of candidate intervals for the example shown in FIGS. 18A-E.

FIG. 18D shows a data structure that may be used to represent a candidate interval. The data structure includes fields that numerically represent the starting point of the candidate interval 1830 and the size, or length, of the candidate interval 1832, either in mega bases or in probes. The data structure optionally includes an additional field to indicate the chromosome in which the candidate interval has been identified 1834. This field is optional because candidate intervals can be considered to be specific to particular chromosomes, in which case a chromosome identifier may be needed, or can be considered to be associated with the entire genome, in which case a chromosome-identifying field 1834 is not needed. In other words, the value that describes the starting point may be relative to a particular chromosome or may be relative to a sequential ordering of all chromosomes of the genome into a single sequence. In an alternative embodiment, the data structure may include fields that numerically represent the starting and ending pints for the candidate interval. In the described methods for identifying candidate intervals and in subsequently described computation of per-sample and cumulative significance scores for candidate intervals, only the starting point and size, or the starting and ending points, of each candidate interval are taken into account.

FIG. 18E shows all candidate intervals determined for the hypothetical multi-sample data set shown in FIGS. 18A-B. The first five horizontal rows 1836-1840 of candidate intervals in FIG. 18E include aberrant intervals originally identified by a per-sample application of an aberration-calling technique, and the remaining three horizontal rows 1842-1844 of candidate intervals represent intersection intervals between pairs of the originally identified aberrant intervals shown in horizontal lines 1836-1840. By considering all possible intersection intervals generated from pair-wise consideration of the originally identified intervals, all possible m-way intersection intervals are obtained, where m ranges from 2 to n, the number of samples.

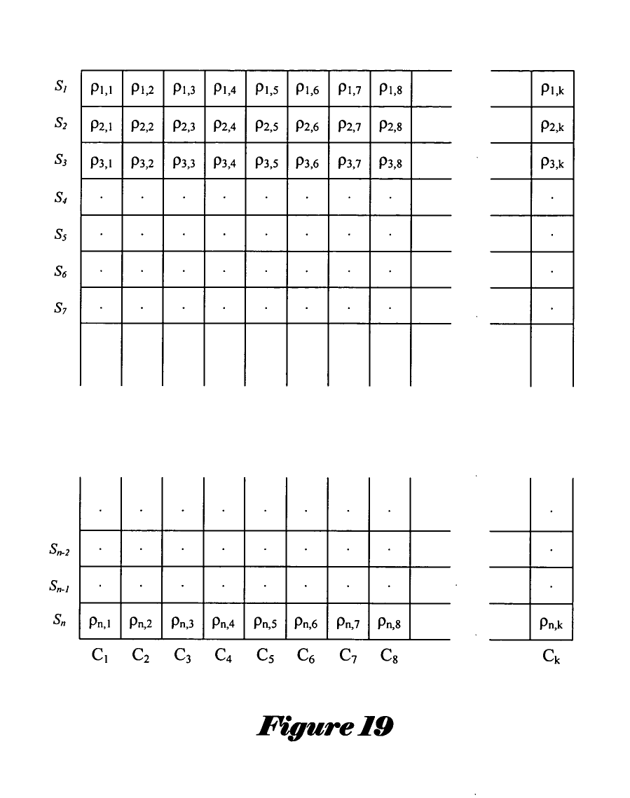

In a next step employed in method and system embodiments of the present invention for identifying statistically significant, common aberrations in a multi-sample CGH or aCGH data set, a first, initial statistical score is assigned to each candidate interval for each sample in the multi-sample data set for amplification, and a second, initial score is assigned to each candidate interval for each sample in the multi-sample data set for deletion. In other words, each candidate interval is evaluated with respect to each sample to produce a statistical score for each candidate-interval/sample pair with respect to amplification and with respect to deletion. FIG. 19 shows an illustration of the per-sample statistical scores generated for each candidate-interval/sample pair for one of amplification or deletion. As shown in FIG. 19, results of this first scoring step can be considered to be a 2-dimensional array of statistical scores, such as the statistical score ρ_{1,1} 1902 representing the statistical score generated for the candidate interval c₁ when the candidate interval c₁ is evaluated with respect to sample S₁ for one of amplification or deletion. A number of different statistical scores can be computed by a number of different methods in various alternative embodiments of the present invention. In one embodiment, the above-discussed score S(I) produced by the above-described aberration-calling mechanism may be used as the statistical score for each candidate interval. In this case, the candidate interval is statistically scored, with respect to the chromosome in which the candidate interval was initially detected, in each of the sample data sets.

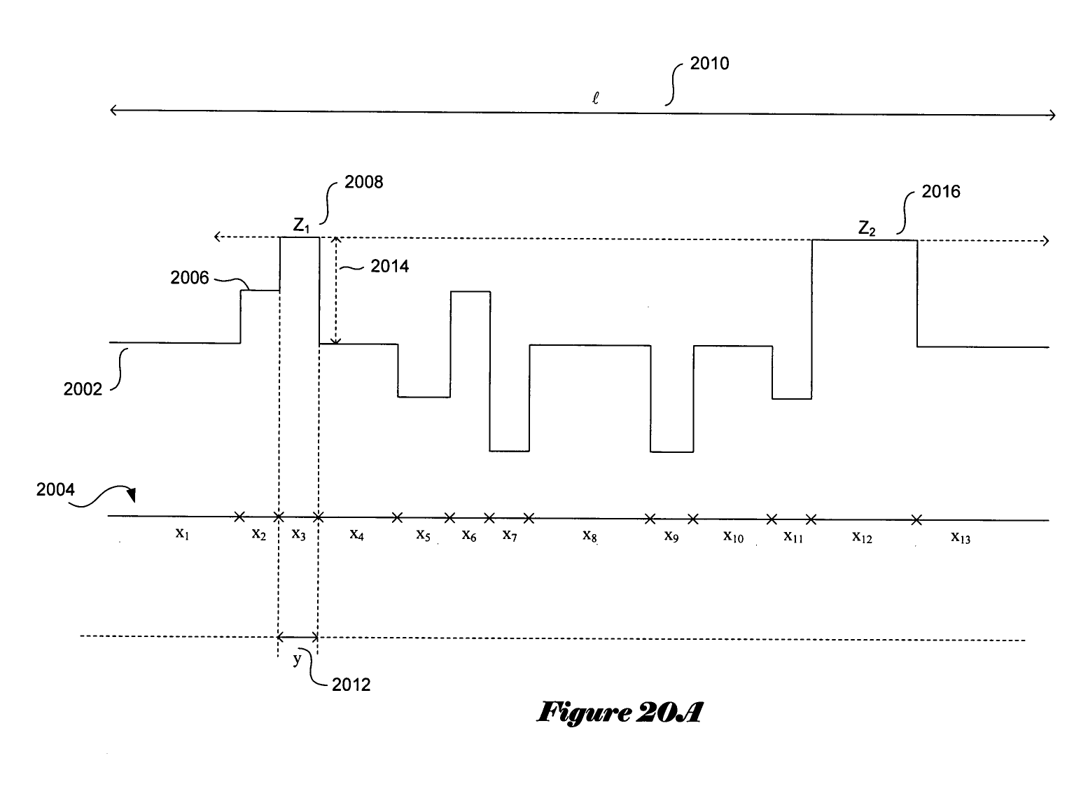

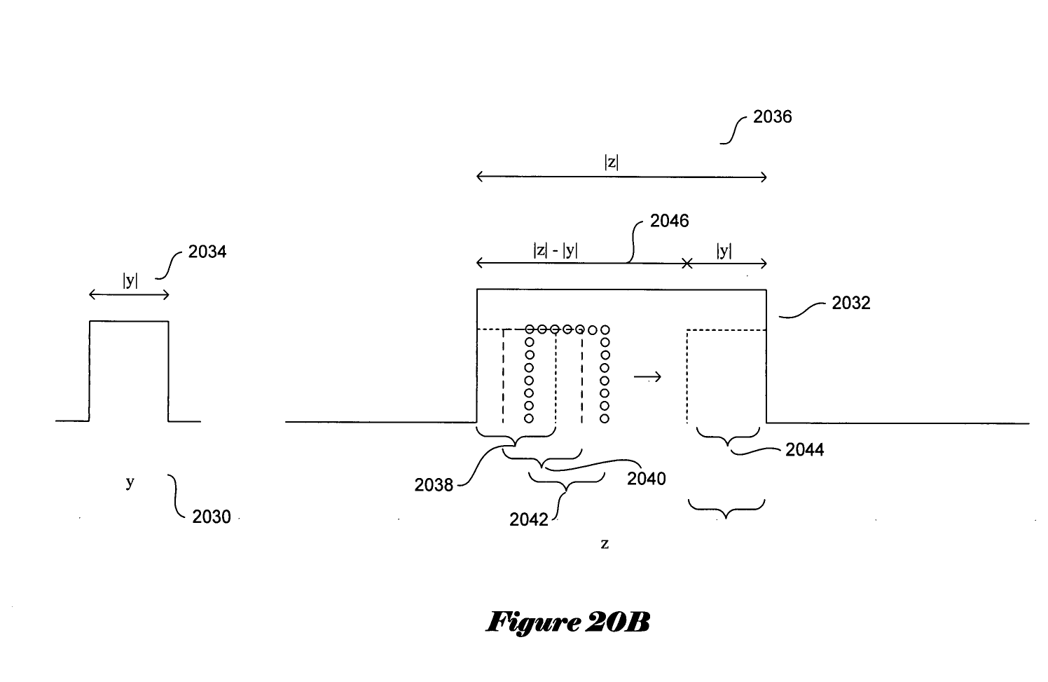

In alternative embodiments, a chromosome-context-based method or a genome-context-based method can be used to determine a statistical score for each candidate interval with respect to each sample and with respect to amplification or deletion. FIGS. 20A-B illustrate computation of a context-based statistical score. The computation of the context-based statistical score is essentially the same in both the chromosome-context and genome-context embodiments. A step-function-like representation of aberrations identified in the chromosome from which the candidate interval was originally identified, in the chromosome-context-based method, or a step-function-like representation of the entire genome, in the genome-context-based method, is first prepared. FIG. 20A shows a step-function-like representation of either a chromosome context or genome context 2002. Each step of the step function is separately considered. For example, in the step-function-like representation of the context 2002 shown in FIG. 20A, 13 steps, or step intervals, are identified, as shown in the horizontal line of step intervals 2004. Certain of these step intervals may exactly coincide with aberrant intervals identified by aberration-calling method. However, in the case of nested aberrant intervals, certain of these steps, or step intervals, may represent superpositions of two different nested aberrant intervals. For example, the two step intervals x₁ 2006 and x₂ 2008 in the step-function-like representation may result from a first aberrant interval and a second aberrant interval identified by the aberration-calling method. However, these two step intervals may also correspond to a narrow four-fold amplification, coinciding with step 2008, nested within, or superimposed on, a longer, two-fold amplification that spans steps 2006 and 2008. In the described method, it is immaterial whether steps represent nested aberrant intervals or discrete, separated aberrant intervals.

The context, either a chromosome or the entire genome, has a context length 2010 represented by the symbol “l.” A candidate interval 2012 is represented by the symbol “y.” The context-based statistical score is essentially proportional to the probability that the region of the context corresponding to the candidate interval y is either amplified, in the case of the amplification related initial statistical score, or deleted, in the case of the deletion-related statistical score, in the chromosomal or genomic context for a particular sample. In a first step of the context-based method, the magnitude 2014 of either the amplification or deletion of the region of the context corresponding to the candidate interval y is determined. For computing a context for context-based determination of a per-sample statistical score with respect to amplification, the minimum height of any step interval that occurs in a region of the sample corresponding to the candidate interval is selected as the candidate interval height with respect to the sample. For computing a context for context-based determination of a per-sample statistical score with respect to deletion, the maximum height of any step interval that occurs in a region of the sample corresponding to the candidate interval is selected as the candidate interval height with respect to the sample. Then, the remaining step intervals are compared to candidate interval height 2014. In the case of computing an amplification-related statistical score, only those step intervals with heights equal to, or greater than, the candidate interval height 2014 and with widths equal to, or greater than, the candidate interval width are considered along with the step interval corresponding to the candidate interval y. In the current example, only the step interval corresponding to the candidate interval y 2008 and the final step interval in the context, step interval 2016, are therefore considered. These two intervals together comprise the set of qualified intervals {z₁, z₂}, in which the context-based statistical score is computed. A similar process is used to generate qualified intervals when the candidate interval y is considered for deletion. In the deletion case, only those step intervals with heights equal to, or lower in height than, the candidate interval height and with widths equal to, or greater than, the candidate interval width are considered as qualified intervals.

Next, as shown in FIG. 20B, the candidate interval y 2030 is compared to each qualified interval, such as qualified interval z 2032 shown in FIG. 20B. The candidate interval y has length |y| 2034 and the qualified interval to which it is being compared has length |z| 2036. Consider placing the candidate interval y within the qualified interval z such that the candidate interval y is contained completely within the qualified interval z. The qualified interval could be placed at a first position 2038 in which the left-hand edge of the candidate interval y coincides with the left-hand edge of the qualified interval z. The candidate interval could be moved rightward, through a continuous set of intermediate positions, such as intermediate positions 2040 and 2042, up to a final position 2044 in which the right-hand edge of the candidate interval y coincides with the right-hand edge of the qualified interval z. In other words, the starting position of the candidate interval y could fall anywhere within a length of |z|-|y| 2046 and allow the candidate interval y to be fully contained within the qualified interval z. Similarly, the starting point for the candidate interval y could be placed anywhere along a line segment of length |y|-|y| in order to be fully contained within a context of length |l|. The probability that the candidate interval y may occur within an interval of a length equal to a qualified interval z, P(y⊂z), is thus:

$$P ( y ⊆ z ) = \frac{\vert z \vert - \vert y \vert + ɛ}{\vert ℓ \vert - \vert y \vert + ɛ}$$

where ε is a constant of small magnitude that prevents numerical instability in certain boundary cases. The probability that the candidate interval y is aberrant within a sample Sᵢ, P(y is an abberation in Sᵢ), is then:
P(y is an abberation in Sᵢ)≡Σₖ₌₁^{q}P(y⊂zₖ)
where k ranges from 1 to the number of qualified intervals q. The computed probability P(y is an abberation in Sᵢ) is used as the context-based statistical score assigned to candidate interval y for a sample Sᵢ in one embodiment of the present invention. The statistical score represents a probability that the candidate interval is aberrant within a particular sample. The statistical scores range from 0, indicating no probability of the interval being aberrant, to 1, indicating a 100 percent probability that the candidate interval is aberrant.

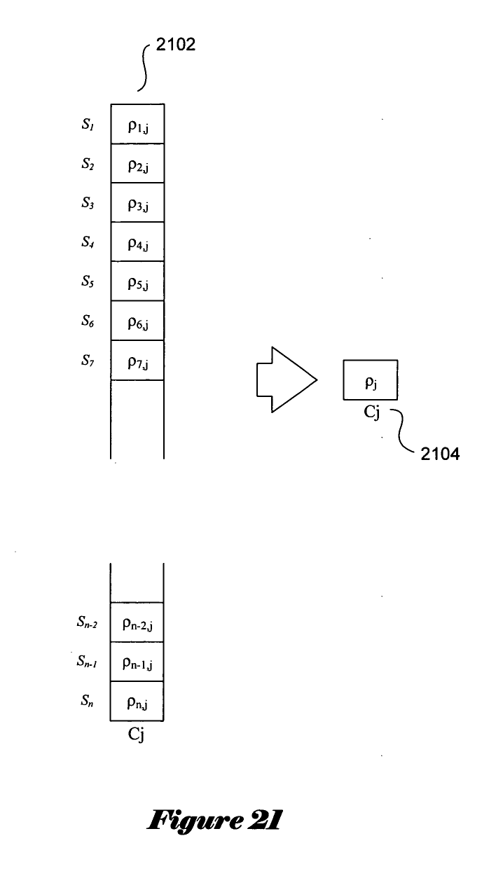

By whatever method a per-sample statistical score is assigned to each candidate interval with respect to each sample and with respect to one of amplification and deletion, the above-described step of the process employed in method and system embodiments of the present invention for identifying statistically significant, common aberrations in a multi-sample data set results in two, 2-dimensional arrays of statistical scores such as the 2-dimensional array of statistical scores shown in FIG. 19. In a next step of the process, the per-sample statistical scores for each candidate interval are used to compute a cumulative significance score for each candidate interval for each of amplification and deletion. FIG. 21 illustrates computation of a cumulative significance score for each candidate interval. As shown in FIG. 21, the per-sample statistical scores for a particular candidate interval cⱼ for one of amplification or deletion represents a single column 2102 of a 2-dimensional matrix as shown in FIG. 19. Computation of a cumulative significance score for a candidate interval involves computing, from the column of per-sample statistical scores 2102 associated with the candidate interval cⱼ, a single scalar value 2104 representing the cumulative significance score for the candidate interval cⱼ.

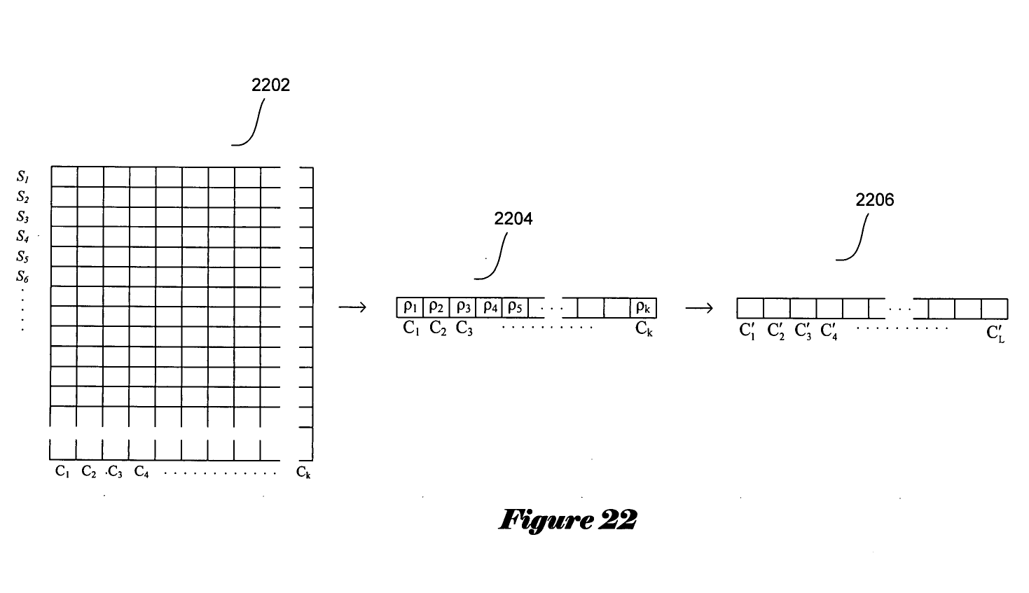

FIG. 22 illustrates remaining steps, following preparation of the 2-dimensional arrays of per-sample statistical scores discussed with reference to FIG. 19, of a process for identifying statistically significant candidate intervals that represents on embodiment of the present invention. As shown in FIG. 22, a 2-dimensional array of per-sample statistical scores 2202, each column of which represents a set of per-sample statistical scores computed for a given candidate interval, is collapsed, by the method described above with reference to FIG. 21, into a row vector 2204 containing cumulative significance scores for each candidate interval cⱼ. In a final step, the row vector may be sorted to produce a sorted row vector 2206 in which the cumulative significance scores occur in increasing numerical value, or decreasing significance. In other words, in the sorted row vector, the candidate intervals that index the row vector occur in descending order with respect to statistical significance. Therefore, a threshold statistical value may be used to select the most significant candidate intervals that together comprise a right-hand prefix of the row vector, which may then be returned as the set of statistically significant candidate intervals. In certain embodiments of the process, the method by which per-sample statistical scores are collapsed into cumulative significance scores result in a sorted row vector, without need for a discrete sorting step.

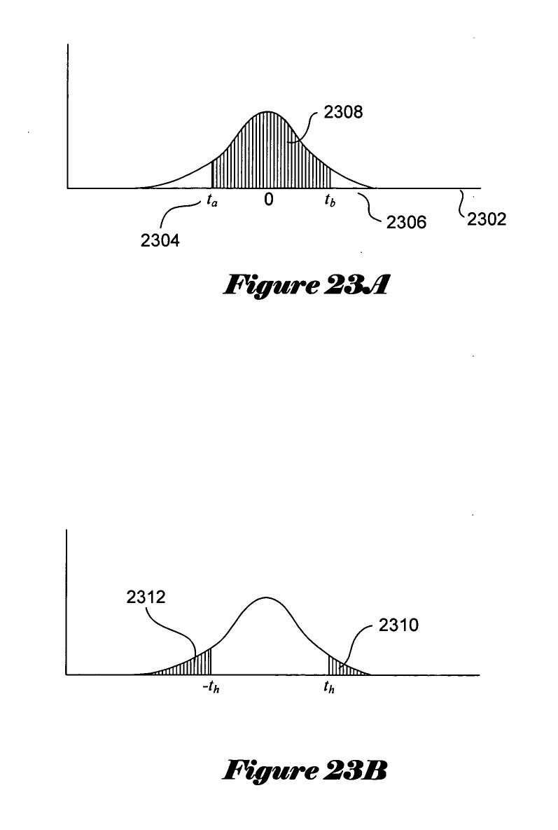

In certain embodiments of the present invention, a cumulative significance score for each candidate interval with respect to each of amplification and deletion is computed from the per-sample statistical scores for the candidate interval based on t-test statistics. FIGS. 23A-B shows a t-test probability distribution f(t). The t-test probability density function f(t) is plotted in FIG. 23A with respect to the variable t, a continuous domain of values of which are represented by horizontal axis 2302. The area under the t-test probability-density-function curve is equal to 1.0 or, in other words, the t-test distribution is normalized. The probability that the value of the variable t falls within a range [tₐ,t_{b}] is equal to the area under the t-test curve between the t values tₐ 2304 and t_{b} 2306. The area is shaded 2308. Thus, the probability that t lies between tₐ and t_{b} is given by:

$$P ( {t}_{a} \leq t \leq {t}_{b} ) = {\int }_{t = {t}_{a}}^{{t}_{b}} f ( t ) ⅆ t$$

In one embodiment of the present invention, the total statistical score for a candidate interval is estimated as the average of the per-sample statistical scores, ρᵢ, computed according to the methods described above or according to other per-sample-statistical-score-computing methods:

$$\overline{y} = \frac{1}{n} {\sum }_{i = 1}^{n} {ρ}_{i}$$

and the variance for the per-sample statistical scores ρᵢ is estimated as:

$${S}^{2} = \frac{1}{n - 1} {\sum }_{i = 1}^{n} {( {ρ}_{i} - \overline{y} )}^{2}$$

In one embodiment of the present invention, the S(I) scores returned by an aberration-calling method are used for the per-sample statistical scores ρᵢ. A quantity T may be defined as:

$$T = \sqrt{n} ( \frac{\overline{y}}{S} )$$

where \vec{y} is the estimated average of the per-sample statistical scores,

n is the number of observations, and

S is the observed variance.

T is distributed according to the t-test distribution, which allows for assigning a probability that the estimated average differs from 0 by bounds related to the variance.

A p-value for a particular hypothesis, such as the hypothesis that an interval is not aberrant, can be derived from a t-test distribution. A t-test distribution with n-1 degrees of freedom can be computed for a t-test-distributed quantity and can be used to estimate the probability of observing a particular value for the t-test-distributed quantity, such as the T statistic discussed above, in a test with n samples. FIG. 23B shows areas 2310 and 2312 under the tails of a t-test probability density function distribution. When the left-hand boundary of the right-hand tail is set to the value tₕ, the area of the right-hand tail represents the probability of observing a computed value greater than tₕ. The p-value of a statistical hypothesis test is the probability of observing a value of a test statistic as extreme as or more extreme than an observed value of the test statistic. When the computed probability, or p-value, is less than a threshold p-value, the null hypothesis is rejected. For example, when the p-value computed for a T statistic is less than a threshold value, such as 0.05, then the hypothesis that the interval is not amplified may be rejected. Thus, the area under the right-hand tail bounded by tₕ corresponds to the p-value for an observed test statistic with value tₕ. Two-sided tests can be used when the computed test statistic can be either positive or negative, such as when the computed test statistic is related to the magnitude of a value. Two-sided tests are based on the areas under both tails, bounded by values tₕ and −tₕ. One-sample t-tests can be used for estimating p-values for a test statistic computed from one set of samples. A two-sample t-test can be used to compute a p-value for a test statistic computed from two different sets of samples, useful for testing a hypothesis such as the hypothesis that the two different sets of samples both have a common mean test-statistic value and are equivalently distributed. In one embodiment of the present invention, the cumulative significance score for a candidate interval is computed as a combination of the average of the per-sample statistical scores and a p-value obtained by one-sample t-test statistics assuming the candidate interval to be present at a normal copy number. For computing the cumulative significance score with respect to amplification, a one-sided t-test based on the right-hand tail is employed. For computing the cumulative significance score with respect to deletion, a one-sided t-test based on the left-hand tail is employed.

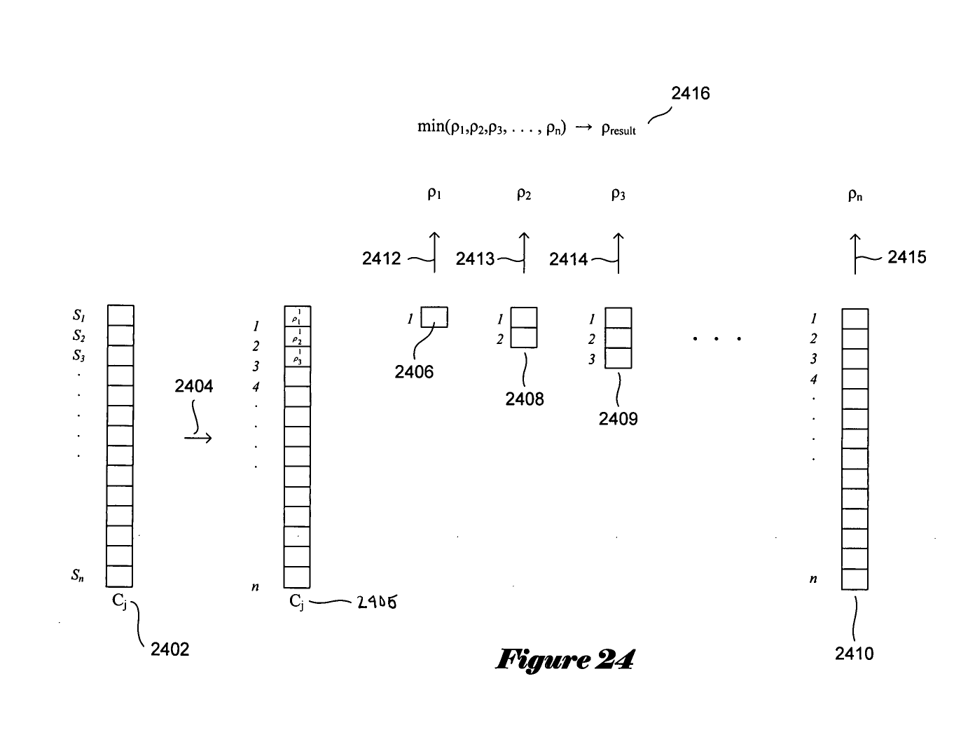

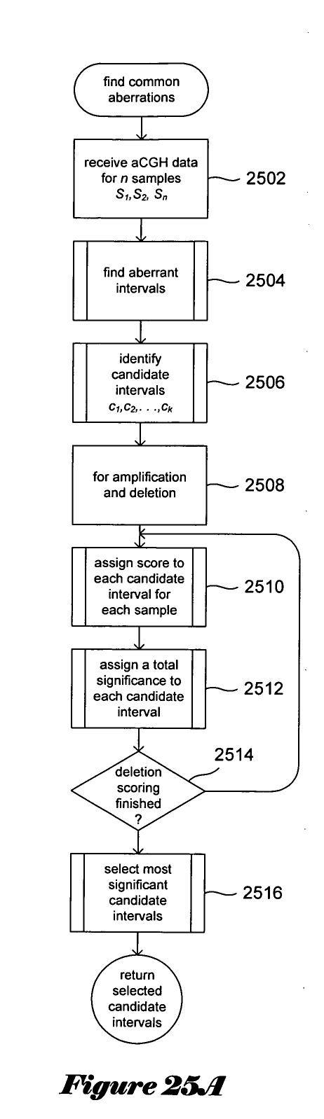

FIG. 24 illustrates an alternative method for computing a cumulative significance score for a candidate interval. The alternative method starts with a column vector 2402 containing per-sample statistical scores for a particular candidate cⱼ. First, the statistical scores are sorted 2404 to produce a modified column vector in which the statistical scores ascend in numerical order with increasing indexes, or, in other words, are ordered most surprising to least surprising. Next, prefix vectors of the modified column vector are generated, beginning with a first prefix vector including only the first element of the modified column vector 2406 and proceeding through prefixes of monotonically increasing length 2408-2409 to a final, longest prefix vector equal to the original, modified column vector 2410. A statistical score is computed for each prefix, indicated in FIG. 24 by the vertical arrows 2412-2415 pointing to computed statistical scores P₁, P₂, . . . Pₙ. In one embodiment of the present invention, the minimum numerically valued statistical score, or the statistical score indicating the least probability, is chosen as the resulting cumulative significance score 2416 for the candidate interval cⱼ. In alternative embodiments of the present invention, another minimally or maximally valued score or metric, such as the minimal false discovery rate, may be selected as the resulting cumulative significance score.

A number of different scores may be computed, by various methods, and assigned to prefix vectors for use in computing a cumulative significance score as described with reference to FIG. 24. In one method, a prefix score can be computed as the estimated average of the scores in the prefix combined with a p-value generated from t-test statistics. In an alternative method, a Chernoff bound is employed to compute a p-value -like score. A Chernoff bound may be is described as follows:
Let X₁, . . . , Xₙ, be independent random variables such that P(X₁)=p₁.

$$Let Z = {\sum }_{i = 1}^{n} {X}_{i} and let μ = E [ Z ] . \\ Then P ( Z \geq ( 1 + δ ) μ ) < {( \frac{{ⅇ}^{δ}}{{( 1 + δ )}^{( 1 + δ )}} )}^{μ}$$

The Chernoff bound is applied to a prefix vector of length k containing k statistical scores ρ₁, ρ₂, . . . , ρₖ, where ρ₁≦ρ₂≦ . . . ≦ρₖ, as follows:

$$\hat{p} = {ρ}_{k}$$

$$μ = ( \hat{p} ) ( n )$$

$$δ = \frac{k - μ}{μ}$$
if δ equals 0, then Pₖ=0 else

$${log}_{10} {P}_{k} = μ ( \frac{δ}{ln ( 10 )} - ( 1 + δ ) {log}_{10} ( 1 + δ ) )$$

The values log₁₀Pₖ or the value Pₖ computed above for a prefix can be used as the statistical score for the k^{th} prefix in the method discussed with reference to FIG. 24.

Similar methods can be employed to determine whether or not a candidate interval shows a significance difference in copy number in one group of samples with respect to another group of samples. In one embodiment of the present invention, a difference in copy number for a candidate interval c in a first group of samples S₁={u₁, u₂, . . . , uₙ} and a second group of samples S₂={v₁, v₂, . . . , vₘ} is determined by: (1) computing S(I) values for the candidate interval with respect to each sample in S₁ and S₂, computing a t-test-distributed test statistic related to the S(I) values for candidate interval c with respect to each of the two groups of samples S₁ and S₂, and then using a two-sample t test to decide whether the S(I) scores for the two groups of samples S₁ and S₂ are similarly distributed as well as the p-value associated with the determination. All candidate intervals for the two groups of samples S₁ and S₂ can be evaluated by the two-sample t test method and each candidate interval can be assigned a score reflective of the probability that the copy number of the candidate interval differs in the two groups of samples. The candidate intervals can then be sorted according to the assigned scores, to reveal the candidate intervals most likely to be present in different copy numbers in the two groups of samples.

The method of evaluating candidate intervals for similar distribution in two groups of samples can be extended to analysis of k groups of samples, where k is greater than 2. For example, candidate intervals that are dissimilarly distributed in the k different samples may be found by pairwise application of two-sample t-test-based statistical methods or by ANOVA statistical methods based on the F-distribution. The degree of dissimilarity may be numerically expressed in different ways depending on the statistical analysis method used, and used to order candidate intervals by their ability to distinguish groups of samples by comparing aberration-calling results for the candidate intervals in the k groups of samples.

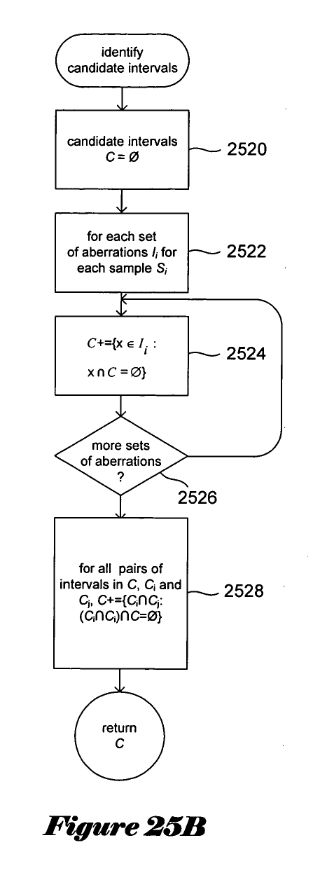

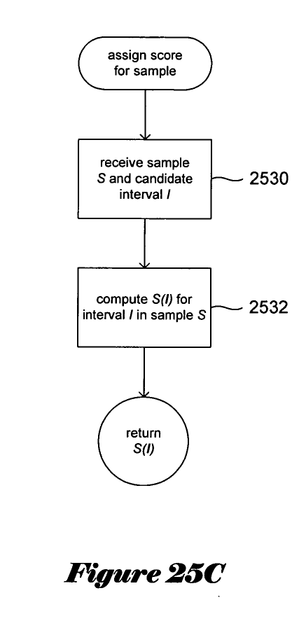

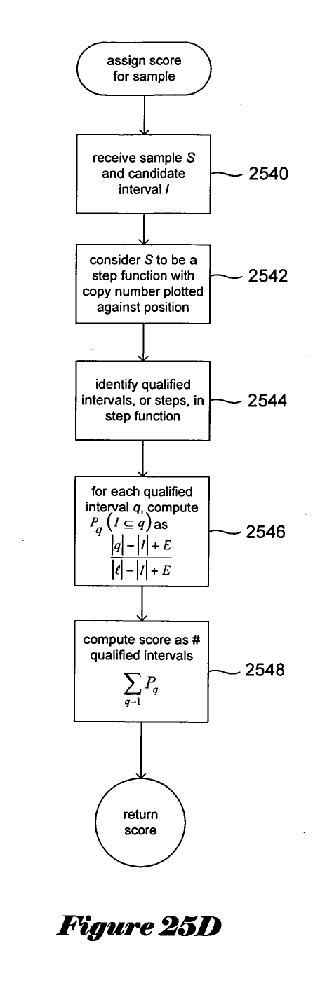

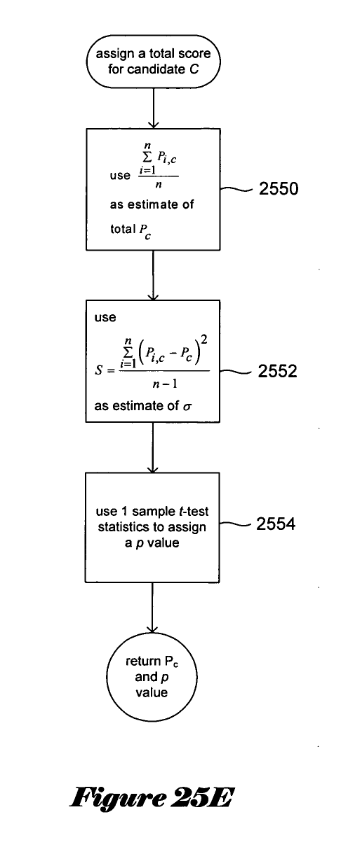

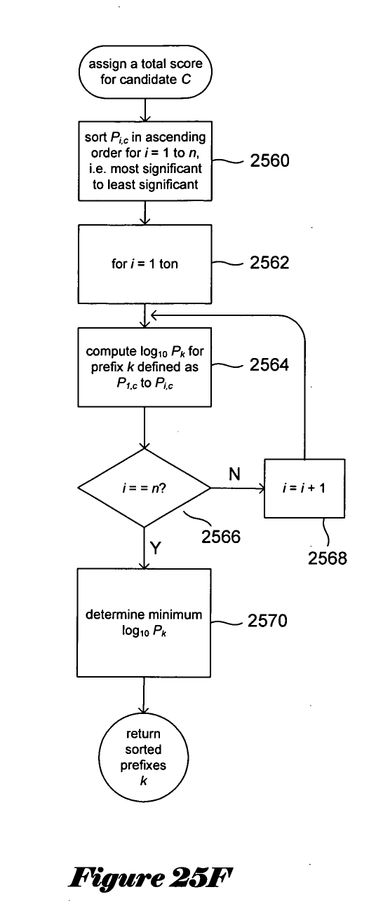

FIGS. 25A-F show control-flow diagrams that illustrate a number of steps in various embodiments of the present invention. FIG. 25A shows a control-flow diagram illustrating a routine “findCommonAberrations” that represents an overall approach, or computational framework, for many embodiments of the present invention. In a first step 2502, the routine “findCommonAberrations” receives a CGH or aCGH data set comprising CGH or aCGH data for n samples S₁, S₂, . . . , Sₙ. Next, in step 2504, the routine “findCommonAberrations” invokes any of numerous different aberration-calling methods, such as the aberration-calling method discussed in the previous subsection, to identify aberrant intervals in the chromosomes of each of the different n samples. Next, in step 2506, the routine “findCommonAberrations” identifies a set of candidate intervals c₁, c₂, . . . , cₖ using the method discussed above with reference to FIGS. 18A-E. In the for-loop including steps 2508, 2510, 2512, and 2514, steps 2510 and 2512 are executed twice, once for assigning a cumulative significance score to each candidate interval with respect to amplification and once for assigning a cumulative significance score to each candidate interval with respect to deletion. In step 2510, a per-sample score is assigned to each candidate interval for each sample to generate a 2-dimensional array of per-sample scores, such as the 2-dimensional array of per-sample scores shown in FIG. 19. Then, in step 2512, per-sample statistical scores generated for each candidate interval are used to compute a cumulative significance score for each candidate interval, as described above with reference to FIG. 21. Finally, in step 2516, the most significant candidate intervals are selected based on the cumulative significance scores assigned to each candidate interval, and the most significant candidate intervals are returned. In many embodiments of the present invention, the returned significant candidate intervals are each accompanied with indications of the sample subsets in which the interval is aberrant.

FIG. 25B shows a control-flow diagram for one approach to identifying a set of candidate intervals C for a multi-sample aCGH data set. In step 2520, the set of candidate intervals C is set to null. Next, in the for-loop of steps 2522, 2524, and 2526, each aberrant interval from the set of aberrant intervals identified by the aberration-calling mechanism invoked in step 2504 is considered. If the next considered aberrant interval is not already included in the set of candidate intervals C, then the next considered aberrant interval is included in C in step 2524. Then, in step 2528, all possible intersection intervals generated from pair-wise overlaps of the intervals in C at the completion of the for-loop of steps 2522, 2524, and 2526 are considered, and any such intersection intervals that have not already been added to C are then added to C in order to complete the set of candidate intervals. Efficient techniques that compute all possible intersections from pairs of overlapping intervals in less than [symbol] (n²) time may be employed in step 2528.

FIG. 25C shows a control-flow diagram of one method for assigning a per-sample statistical score to a candidate interval. In step 2530, sample data S and a candidate interval I is received. In step 2532, the statistic S(I) for the received interval I with respect to sample data S is computed as in the aberration-calling program described in the previous subsection.

FIG. 25D illustrates an alternative method for computing a per-sample physical score for a candidate interval. In step 2540, sample data S and the candidate interval I are received. Next, in step 2542, the sample data S is considered as a step-function-like context, as discussed above with reference to FIG. 20A. In step 2544, qualified intervals, or interval steps, are determined by the method discussed above with reference to 20A. Then, in step 2546, a probability is computed for the candidate interval I with respect to each qualified interval and, in step 2548, the computed probabilities are summed together to produce a final statistical score for the candidate interval I with respect to sample S. As discussed above with reference to FIGS. 20A-B, the context may either be a single chromosome or may be the entire genome.

FIG. 25E is a control-flow diagram for a routine that assigns a cumulative significance score to a candidate interval c. In step 2550, an average of the per-sample statistical scores for the candidate interval c is computed. Next, in step 2552, the variance for the per-sample scores is computed. Finally, in step 2554, one-sample t-test statistics are used to assign a p-value to the computed average in order to provide a final, cumulative score for the candidate interval c that reflects both the average of the per-sample scores as well as sample variance of the per-sample statistical scores. The cumulative score may also be computed as any of various mathematical combinations of the average and p-value.

FIG. 25F is a control-flow diagram for an alternate method for computing a cumulative significance score for a candidate interval c. In step 2560, per-sample statistical scores associated with the candidate interval C are sorted in ascending numerical order to produce a column vector, as described with reference to FIG. 24, above. Next, in the for-loop of steps 2562, 2564, 2566, and 2568, a score is computed for each of the prefix vectors, as also discussed above with reference to FIG. 24. Finally, in step 2570, the minimum of the computed scores for the prefixes is determined, and that minimum score is returned as the cumulative significance score for the candidate interval c.

Although the present invention has been described in terms of particular embodiments, it is not intended that the invention be limited to this embodiment. Modifications within the spirit of the invention will be apparent to those skilled in the art. For example, any of the various embodiments of the present invention discussed above may be included in software for analysis of aCGH data as well as in automated instruments and/or system that generate and analyze CGH and aCGH data. The various method embodiments of the present invention may be implemented in any number of different programming languages, using different modular structures, control structures, data structures, variables, and wide variations in other programming parameters. As discussed above, any of many different aberration-calling methods can be used for initially identifying aberrant intervals in a multi-sample CGH or aCGH data set. As also discussed above, any of a large variety of different methods can be used to produce a variety of different types of per-sample statistical scores and cumulative scores for candidate intervals in order to identify the most significant candidate scores. Although the described embodiments are directed to analysis of CGH and aCGH data, the present invention can be more generally applied to identifying subsequences with common properties within multiple sequences.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for identifying subsequences with a characteristic common to the subsequences in multiple samples of a multi-sample sequence data set, the method comprising:
identifying, on a per-sample basis, subsequences in each sample significant with respect to the characteristic;
selecting a set of candidate subsequences that includes non-redundant significant subsequences of the identified subsequences as well as non-redundant subsequences that represent intersections between overlapping pairs of the identified subsequences;
for each candidate subsequence, computing a first statistical score with respect to each sample reflecting the probability of observing the characteristic for the subsequence in the sample corresponding to the candidate subsequence;
for each candidate subsequence, computing a second, cumulative significance score based on the first statistical scores computed for the candidate subsequence; and
identifying as significant subsequences those candidate subsequences for which the computed, second, cumulative significance score indicates significance above a threshold significance-indication level.

2. The method of claim 1 wherein identifying, on a per-sample basis, subsequences in each sample significant with respect to the characteristic further includes computing a statistical score for each subsequence that reflects a probability of the subsequence having the characteristic in the sample.

3. The method of claim 1 wherein selecting a set of candidate subsequences that includes non-redundant significant subsequences of the identified subsequences as well as non-redundant subsequences that represent intersections between overlapping pairs of the identified subsequences further includes;
setting the set of candidate subsequences to the null set;
for each significant subsequence identified in the samples of the multi-sample sequence data set, adding the significant subsequence to the set of candidate subsequences when the significant subsequence does not already occur in the set of candidate subsequences; and
for each possible intersection between pairs of overlapping, significant subsequences, adding the intersection to the set of candidate subsequences when the intersection does not already occur in the set of candidate subsequences.

4. The method of claim 1 wherein computing a first statistical score with respect to each sample reflecting the probability of observing the characteristic for the subsequence in the sample corresponding to the candidate subsequence further includes:
computing a statistical score for the candidate subsequence that reflects a probability of observing the characteristic for the candidate subsequence in the sample.

5. The method of claim 1 wherein computing a first statistical score with respect to each sample reflecting the probability of observing the characteristic for the subsequence in the sample corresponding to the candidate subsequence further includes:
identifying qualified candidate subsequences in the sample; and
computing the first statistical score as a sum of probabilities, each probability corresponding to a qualified subsequence and calculated as a ratio of a size of the candidate sequence subtracted from a size of the qualified subsequence, the subtrahend then divided by the size of the candidate sequence subtracted from a total sample size.

6. The method of claim 1 wherein computing a second, cumulative significance score based on the first statistical scores computed for the candidate subsequence further comprises:
computing a mean of the first statistical scores;
computing a sample variance of the first statistical scores;
computing a p-value based on one-sample t-test statistics; and
computing the second, cumulative significance score as a mathematical combination of the computed mean p-value.

7. The method of claim 1 wherein computing a second, cumulative significance score based on the first statistical scores computed for the candidate subsequence further comprises:
ordering the first statistical scores computed for the candidate subsequence;
computing an intermediate statistical score from all possible prefixes of the ordered first statistical scores; and
selecting as the second, cumulative significance score the least probable, computed intermediate statistical score.

8. Computer instructions encoded in a computer readable memory that implement the method of claim 1.

9. A method for identifying statistically significant, aberrant intervals common to multiple samples of a multi-sample, comparative genomic hybridization (“CGH”) data set, each sample including CGH data for one or more chromosomes, the method comprising:
for each sample in the multi-sample CGH data set, employing an aberration-calling method to identify aberrant intervals in the one or more chromosomes for which CGH data is included in the sample;
initially selecting, as candidate intervals, the unique aberrant intervals identified in each sample by the aberration-calling method;
adding to the candidate intervals all unique subintervals representing intersections between pairs of overlapping, initially selected candidate intervals;
to each candidate-interval/sample pair, assigning at least one initial statistical score reflective of the statistical significance of an aberration occurring in the sample in an interval corresponding to the candidate interval;
assigning at least one second, cumulative significance score to each candidate interval based on the at least one initial statistical score assigned to candidate-interval/sample pairs that include the candidate interval;
identifying as statistically significant those candidate intervals with second, cumulative significance scores indicating significance above a threshold significance level.

10. The method of claim 9 wherein assigning an initial statistical score to a candidate-interval/sample pair further includes:
assigning to the candidate-interval/sample pair a statistical score S(I) computed by the aberration-calling method for amplification of an interval I corresponding to the candidate interval in the sample S.

11. The method of claim 9 wherein assigning an initial statistical score to a candidate-interval/sample pair further includes:
assigning to the candidate-interval/sample pair a statistical score S(I) computed by the aberration-calling method for deletion of an interval I corresponding to the candidate interval in the sample S.

12. The method of claim 9 wherein assigning an initial statistical score to a candidate-interval/sample pair further includes:
identifying qualified intervals within the sample;
for each qualified interval q, computing a probability P_{q} of an aberration of a length equal to the length of the candidate interval occurring within a region of the sample equal in length to the length of the qualified interval; and
summing together the computed probabilities P_{q} for all qualified intervals.

13. The method of claim 12 wherein assigning an initial statistical score to a candidate-interval/sample pair further includes:
for computing an initial statistical score with respect to amplification, identifying as qualified intervals those intervals in a step-function-like representation of the sample with heights greater than or equal to a computed candidate interval height, where the computed candidate interval height is the minimum height of any interval in the step-function-like representation of the sample spanned by the candidate interval.

14. The method of claim 12 wherein assigning an initial statistical score to a candidate-interval/sample pair further includes:
for computing an initial statistical score with respect to deletion, identifying as qualified intervals those intervals in a step-function-like representation of the sample with heights lower than or equal to a computed candidate interval height, where the computed candidate interval height is the maximum height of any interval in the step-function-like representation of the sample spanned by the candidate interval.

15. The method of claim 9 wherein assigning a cumulative significance score to each candidate interval based on the at least one initial statistical score assigned to candidate-interval/sample pairs that include the candidate interval further includes:
computing the second, cumulative significance score as a mathematical combination of a mean and variance of the at least one initial statistical score assigned to candidate-interval/sample pairs that include the candidate interval.

16. The method of claim 9 wherein assigning a cumulative significance score to each candidate interval based on the at least one initial statistical score assigned to candidate-interval/sample pairs that include the candidate interval further includes:
ordering the at least one initial statistical score assigned to candidate-interval/sample pairs that include the candidate interval in decreasing-significance order;
computing an intermediate statistical score for each prefix of the ordered, at last one initial statistical score; and
selecting as the second, cumulative significance score a most significant computed intermediate statistical score.

17. The method of claim 16 wherein intermediate statistical score for a prefix is derived from a Chernoff bound for the sum of the first statistical scores in the prefix.

18. The method of claim 16 wherein intermediate statistical score for a prefix is derived from t-test statistics based on the first statistical scores in the prefix.

19. Computer instruction encoded in a computer-readable medium that implement the method of claim 9.

20. A method for identifying a set of statistically significant genomic intervals which best differentiate k groups of samples of a multi-sample, comparative genomic hybridization (“CGH”) data set from one another, each sample including CGH data for one or more chromosomes, the method comprising:
for each sample in the multi-sample CGH data set, employing an aberration-calling method to identify aberrant intervals in the one or more chromosomes for which CGH data is included in the sample;
initially selecting, as candidate intervals, the unique aberrant intervals identified in each sample by the aberration-calling method;
adding to the candidate intervals all unique subintervals representing intersections between pairs of overlapping, initially selected candidate intervals;
to each candidate-interval/sample pair, assigning at least one initial statistical score reflective of the statistical significance of an aberration occurring in the sample in an interval corresponding to the candidate interval;
identifying as the set of statistically significant those candidate intervals with initial statistical scores most dissimilarly distributed in the k groups of samples.

21. The method of claim 20 wherein k equal 2 and t-test statistics are used to determine a degree of differential distribution of the initial statistical scores of the candidate intervals.

22. The method of claim 20 wherein k is greater than 2 and pairwise t-test statistics or ANOVA statistics are used to determine a degree of differential distribution of the initial statistical scores of the candidate intervals.

23. An array-based comparative genomic hybridization (“CGH”) data-set analysis system that includes one or more routines that implement a method for identifying statistically significant, aberrant intervals common to multiple samples of a multi-sample, comparative genomic hybridization (“CGH”) data set, each sample including CGH data for one or more chromosomes, by:
for each sample in the multi-sample CGH data set, employing an aberration-calling method to identify aberrant intervals in the one or more chromosomes for which CGH data is included in the sample;
initially selecting, as candidate intervals, the unique aberrant intervals identified in each sample by the aberration-calling method;
adding to the candidate intervals all unique subintervals representing intersections between pairs of overlapping, initially selected candidate intervals;
to each candidate-interval/sample pair, assigning at least one initial statistical score reflective of the statistical significance of an aberration occurring in the sample in an interval corresponding to the candidate interval;
assigning at least one second, cumulative significance score to each candidate interval based on the at least one initial statistical score assigned to candidate-interval/sample pairs that include the candidate interval;
identifying as statistically significant those candidate intervals with second, cumulative significance scores indicating significance above a threshold significance level.


SEQUENCE LISTING (3 sequences)

SEQ ID NO: 1 - DNA, 32 bp, Artificial
  hypothetical sequence for an illustration
actatgacgctttccatccgggctagctctca

SEQ ID NO: 2 - RNA, 21 nt, Artificial
  hypothetical RNA for illustration
acuaugacgcuuuccaucggg

SEQ ID NO: 3 - protein, 6 aa, Artificial
  hypothetical protein sequence for illustration
YDAFHR